(19) United States
(12) Patent Application Publication
(10) Pub. No.: US 2013/0258099 A1
(43) Pub. Date: Oct. 3, 2013

(54) Depth Estimation Device And Operating Method Using The Depth Estimation Device

(71) Applicants: Ilia Ovsiannikov, Studio City, CA (US); Dong Ki Min, Seoul (KR); Yo Hwan Noh, Gyeonggi-do (KR)

(72) Inventors: Ilia Ovsiannikov, Studio City, CA (US); Dong Ki Min, Seoul (KR); Yo Hwan Noh, Gyeonggi-do (KR)

(73) Assignee: SAMSUNG ELECTRONICS CO., LTD., Suwon-si (KR)

(21) Appl. No.: 13/434,381

(22) Filed: Mar. 29, 2012

(51) Int. Cl. H04N 7/18

(52) U.S. Cl. 348/140; 348/E07.085

(57) ABSTRACT

A method of a estimating a depth including outputting an optical signal to an object and estimating a depth between the object and the depth estimation device in response to a gate signal and a reflected optical signal which is reflected from the object, wherein the optical signal includes a plurality of sequences and a phase of a pulse of the optical signal is randomly changed for each of the plurality of sequences.

### BACKGROUND

Example embodiments relate to a depth estimation device and an operating method of a depth estimation device.

A sensor is an element sensing a state of an object, converting a sensing result to an electric signal and outputting a converted electric signal. A sensor may be classified into a light sensor, a temperature sensor, a magnetic sensor and a depth sensor. A depth sensor may estimate a depth to the object based on the time it takes for an optical signal emitted from a light source to reflect back to the depth sensor from the object.

### SUMMARY

Example embodiments of inventive concepts provide a depth estimation device which may improve accuracy of a three dimensional depth estimated data, an operating method thereof and a method of eliminating interference of an external optical signal.

At least one example embodiment is directed to a depth operation method of a depth estimation device, including outputting an optical signal to an object and estimating a depth between the object and the depth estimation device in response to a gate signal and a reflected optical signal where the optical signal is reflected from the object and incident. The optical signal may include a plurality of sequences and a pulse phase may be randomly changed for each of the plurality of sequences. According to an example embodiment, the optical signal includes a delay time corresponding to a multiple of the pulse wavelength. According to an example embodiment, a desired (or alternatively, predetermined) interval of a pulse is filtered to include the delay time.

According to at least one example embodiment, the outputting the optical signal to the object includes outputting a pulse signal from a pulse generator, outputting a phase designated signal from a random number generator, generating an optical emission control signal having a different phase for a desired (or alternatively, predetermined) interval of the pulse signal based on the phase designated signals, and outputting the optical signal from a light source based on the optical emission control signal.

According to at least one example embodiment, the random number generator is configured to output one of a plurality of phase designated signals as the phase designated signal. According to an example embodiment, a plurality of gate signals are input sequentially for a whole frame and each phase of the plurality of gate signals is changed by a desired (or alternatively, predetermined) phase.

According to at least one example embodiment, the step of estimating a depth between the object and the depth estimation device further includes outputting a plurality of sequence pixel signals in response to the reflected light signal and the gate signal and estimating depth information through a phase difference between the reflected optical signal calculated based on the plurality of sequence pixel signals and the gate signal.

According to at least one example embodiment, the step of outputting the plurality of sequence pixel signals processes the external optical signal in a background signal when values of the plurality of sequence pixel signals are randomly output in response to an external optical signal and the gate signal.

According to at least another example embodiment, an operating method of a depth estimation device includes generating an optical emission control signal, controlling an optical signal and an optical detection control signal, controlling a gate signal applied to a depth pixel, each of which includes a plurality of sequences, and adjusting randomly a phase of a pulse per each of the plurality of sequences.

According to at least one example embodiment, the optical emission control signal includes a delay time which is filtering-processed for a desired interval between the plurality of sequences. According to at least one example embodiment, the optical emission control signal changes a phase of the pulse for each of the plurality of sequences based on a phase designated signal. According to an example embodiment, the gate signal is shifted by 90° from a phase of the optical detection control signal based on the optical detection control signal.

At least one example embodiment is directed to a depth estimation device, including a light source configured to output an optical signal to an object, a depth sensor configured to estimate depth information in response to a reflected light from the object, and a timing controller configured to control an operation timing of the depth sensor by transmitting an optical emission control signal to the light source and transmitting an optical detection control signal to the depth sensor, wherein the optical signal includes a plurality of sequences and a phase of a pulse is randomly changed for each of the plurality of sequences.

According to at least one example embodiment, the timing controller includes a pulse generator configured to output a pulse signal, a random number generator configured to generate a random number and output a phase designated signal determined by the random number, and a delay unit configured to receive the pulse signal and the phase designated signal and delay a part of a pulse so that every desired interval of the pulse signal has a different phase in response to the phase designated signal.

According to at least one example embodiment, the random number generator is configured to generate a random number and output the phase designated signal generated based on the random number to the delay unit. According to at least one example embodiment, the timing controller further includes a pulse filter unit configured to delay a desired interval of the pulse signal. According to at least one example embodiment, the depth sensor includes a sensing array including a depth pixel, a correlated double sampling (CDS)/analog to digital converting (ADC) circuit configured to convert and output a plurality of image pixel signals output from the depth pixel into digital pixel signals and a depth estimation device configured to estimate a depth between the object and the depth estimation device based on the digital pixel signals. According to at least one example embodiment, the sensing array includes a depth pixel having a one-tap pixel structure or a two-tap pixel structure. According to at least one example embodiment, the sensing array further includes at least a pixel selected from a color pixel group consisting of a red pixel, a green pixel and a blue pixel.

At least one example embodiment is directed to a method of eliminating an optical signal interference of a depth estimation device, including outputting an optical signal to an object, where a phase of a pulse changes randomly for each of the plurality of sequences, and, processing the external optical signal in a background signal and estimating a depth between the depth estimation device and the object based on the reflected light signal when a reflected optical signal where the optical signal is reflected and incident, and an external optical signal are input.

According to at least one example embodiment, one of a plurality of sequence pixel signals is randomly output in response to the external optical signal and a gate signal which is synchronized with the optical signal and input. According to at least one an example embodiment, identical sequence pixel signals are output in response to the reflected optical signal and the gate signal, and depth information is estimated through a phase difference between the optical signal and the gate signal calculated based on the sequence pixel signals.

According to at least one example embodiment, a depth estimation device includes: a timing controller configured to output an optical emission control signal and an optical detection control signal; a light source configured to output an optical signal to an object based on the optical emission control signal; and a depth sensor configured to receive a reflected optical signal from the object and estimating a distance to the object based on the optical signal and the reflected optical signal.

According to at least one example embodiment, the timing controller includes: a pulse configured to generate a pulse; a random number generator configured to output a random number; a phase delay unit configured to delay a phase of the pulse by an interval dᵣ based on the random number and output the result as the optical detection control signal; and a pulse delay unit configured to delay the optical detection control signal by an interval T_{w} and outputting the result as the optical emission control signal.

According to at least one example embodiment, the phase delay unit is configured to separates the pulse into a plurality of sequences and the interval dᵣ represents different phase differences between each adjacent sequence in the plurality of sequences; and the interval T_{w} represents a time delay between each adjacent sequence in the plurality of sequences.

According to at least one example embodiment, the depth sensor comprises: a sensing array configured to sense the reflected optical signal from the lens, detect a phase difference between the reflected optical signal and the optical signal, and output image pixel signals; a photo gate controller configured to generate a plurality of gate signals based on the optical detection control signal and output the plurality of gate signals to the sensing array; a sampling and conversion circuit configured to sample the image pixel signals and convert the image pixel signals to digital pixel signals; and a depth estimator configured to estimate a distance of the object based on a phase difference between the digital pixel signals.

According to at least one example embodiment, the sensing array detects a phase difference between the reflected optical signal and at least one of the plurality of gate signals, each gate signal having a different phase difference compared to the optical signal.

According to at least one example embodiment an operating method of a depth estimation device includes: outputting an optical emission control signal and an optical detection control signal from a timing controller; outputting an optical signal to an object based on the optical emission control signal; and receiving a reflected optical signal from the object and estimating a distance to the object based on the optical signal and the reflected optical signal.

According to at least one example embodiment, outputting the optical emission control signal and the optical detection control signal from the timing controller includes: generating a pulse from a pulse generator; generating a random number from a random number generator; delaying a phase of the pulse in a phase delay unit by an interval dᵣ based on the random number and outputting a result as the optical detection control signal; and delaying the optical detection control signal in a pulse delay unit by an interval T_{w} and outputting a result as the optical emission control signal.

According to at least one example embodiment, a method includes separating the pulse into a plurality of sequences in the phase delay unit, where the interval dᵣ represents different phase differences between each adjacent sequence in the plurality of sequences and the interval T_{w} represents a time delay between each adjacent sequence in the plurality of sequences.

According to at least one example embodiment, estimating the distance to the object includes: generating a plurality of gate signals based on the optical detection control signal and outputting the plurality of gate signals sequentially; sensing the reflected optical signal, detecting a phase difference between the reflected optical signal and at least one of the plurality of gate signals, and outputting image pixel signals; sampling the image pixel signals and converting the image pixel signals to digital pixel signals; and estimating the distance to the object based on phase differences between the digital pixel signals.

According to at least one example embodiment, each gate signal in the plurality of gate signals has a different phase difference.

### BRIEF DESCRIPTION OF THE DRAWINGS

Example embodiments of inventive concepts will become apparent and more readily appreciated from the following description of the accompanying drawings in which:

FIG. 1 is a diagram illustrating a depth estimation device according to an example embodiment;

FIG. 2 is a block diagram illustrating a timing controller illustrated in FIG. 1;

FIG. 3 is a timing diagram illustrating a waveform of an optical emission control signal and a waveform of an optical detection control signal illustrated in FIG. 2;

FIG. 4 is a block diagram illustrating a depth estimation device according to at least another example embodiment;

FIG. 5 is a flowchart illustrating an operation method of the depth estimation device illustrated in FIGS. 1 and 4;

FIG. 6 is a block diagram illustrating an example embodiment of a timing controller illustrated in FIG. 4;

FIG. 7 is a block diagram illustrating an example embodiment of a random number generator illustrated in FIG. 6;

FIG. 8 is an example embodiment of a truth table generated through the random number generator illustrated in FIG. 7;

FIG. 9 is a flowchart illustrating in detail an operation of the random number generator in a whole flowchart illustrated in FIG. 5;

FIG. 10 is a timing diagram illustrating a waveform of an optical signal, an output signal of a light source, and a waveform of a first gate signal to a fourth gate signal, an output signal of a photo gate controller, which are illustrated in FIG. 4;

FIG. 11 is a sectional flowchart illustrating an operation of a photo gate controller transmitting a gate signal to an one-tap depth pixel illustrated in FIG. 4 in the whole flowchart illustrated in FIG. 5;

FIG. 12A illustrates a layout of a depth pixel having an one-tap pixel structure included in a sensing array illustrated in FIG. 4;

FIG. 12B is a timing diagram of pixel signals detected successively from a depth pixel having the one-tap pixel structure illustrated in FIG. 12A and a phase difference;

FIGS. 13A to 13D are circuit diagrams illustrating a photoelectric conversion element and transistors included in an active region illustrated in FIG. 12A;

FIG. 14 is a conceptual diagram illustrating a frame performed in a rolling shutter mode in a depth sensor of a one-tap structure illustrated in FIG. 12A;

FIG. 15A illustrates layout of a depth pixel having a two-tap pixel structure, which may be included in a sensing array illustrated in FIG. 4;

FIG. 15B is a timing diagram of pixel signals detected successively in a depth pixel having the two-tap structure illustrated in FIG. 15A and a phase difference;

FIG. 16 is a sectional flowchart illustrating an operation of a photo gate controller of FIG. 4, which transmits a gate signal to a depth pixel having the two-tap pixel structure in a whole flowchart illustrated in FIG. 5;

FIG. 17 is a circuit diagram including a plurality of photo gates and a plurality of transistors, which are in the depth pixel of the two-tap structure illustrated in FIG. 16A;

FIG. 18 is a conceptual diagram illustrating a frame performed in a rolling shutter mode in a depth sensor of the two-tap structure illustrated in FIG. 16A;

FIGS. 19A to 19E illustrate a unit pixel included in the sensing array illustrated in FIG. 4;

FIG. 20 illustrates an operation of a plurality of depth estimation devices located adjacently;

FIG. 21A is a timing diagram illustrating a waveform of an optical emission control signal of a first depth estimation device and a waveform of an optical detection control signal of the first distance measurement device illustrated in FIG. 20;

FIG. 21B is a timing diagram illustrating a waveform of an optical emission control signal of a second depth estimation device and a waveform of an optical detection control signal of the first depth estimation device illustrated in FIG. 20;

FIG. 22 is a drawing illustrating an image processing system according to an example embodiment;

FIG. 23 is a drawing illustrating an image processing system according to another example embodiment; and

FIG. 24 illustrates an electronic system including the depth estimation device illustrated in FIG. 1 or FIG. 4 and an interface.

### DETAILED DESCRIPTION OF EXAMPLE EMBODIMENTS

Example embodiments now will be described more fully hereinafter with reference to the accompanying drawings. The example embodiments may, however, be embodied in many different forms and should not be construed as limited to the embodiments set forth herein. Rather, these embodiments are provided so that this disclosure will be thorough and complete. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the example embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

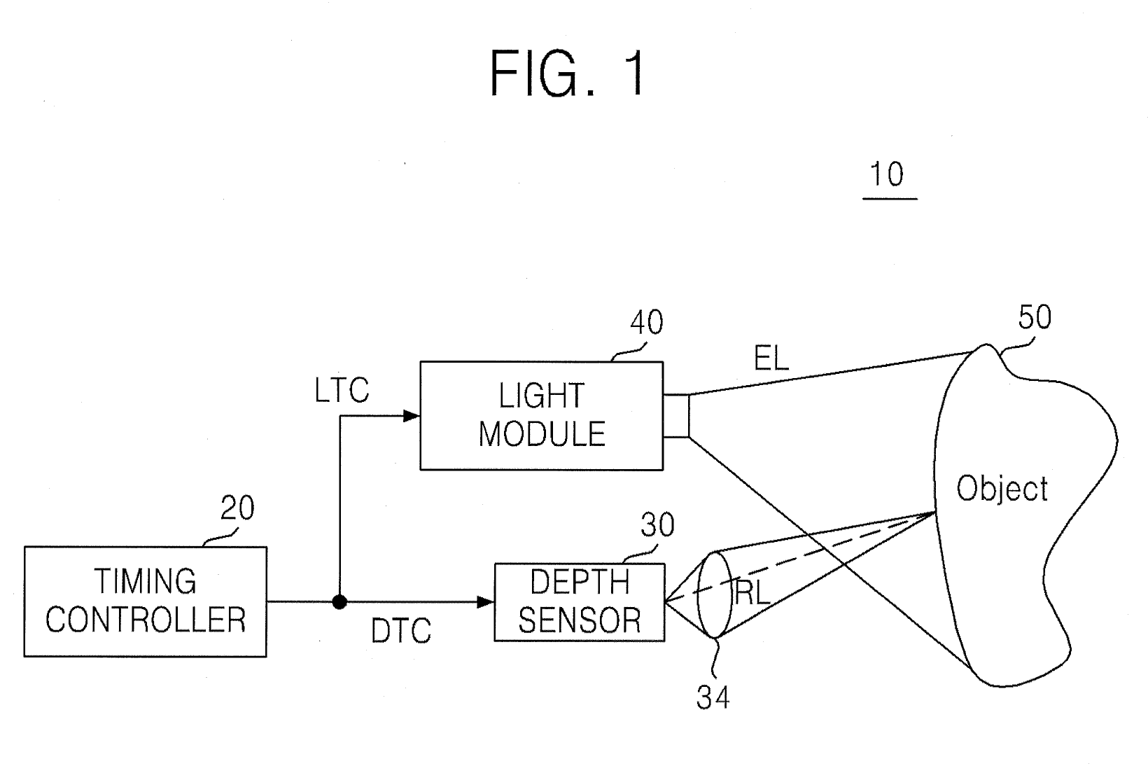

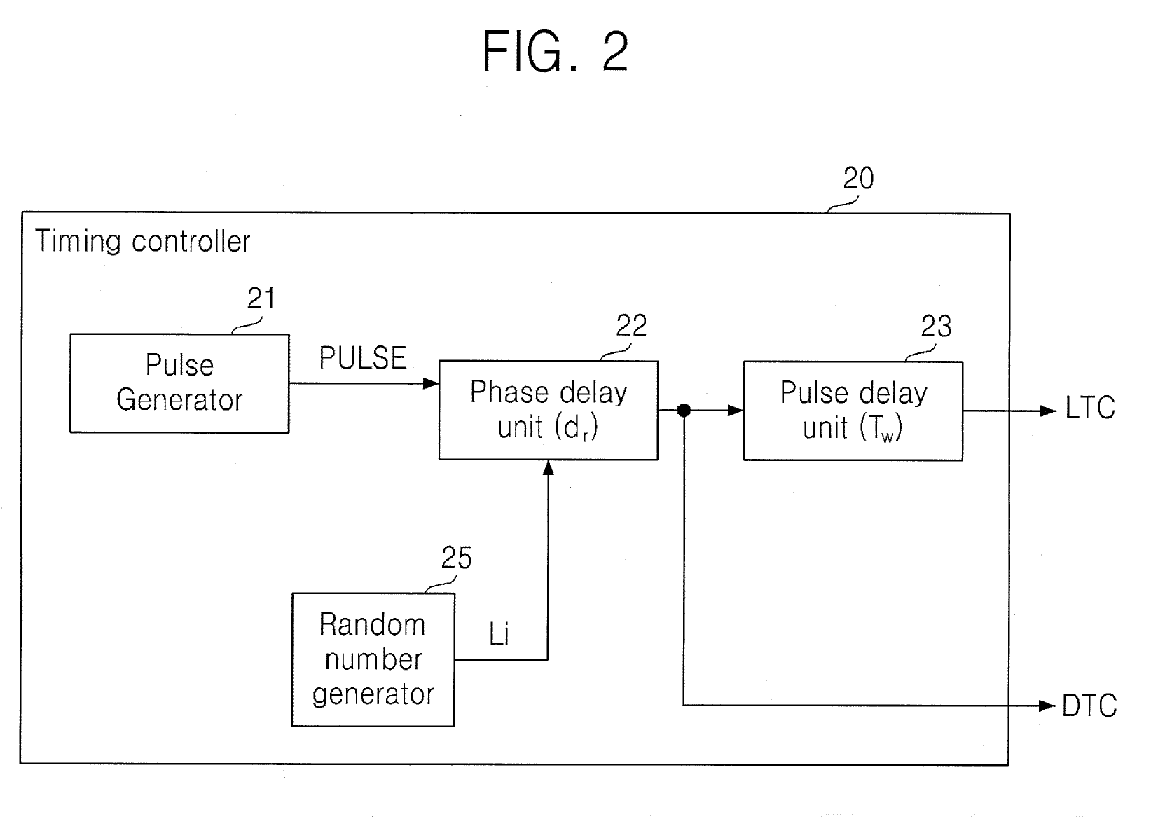

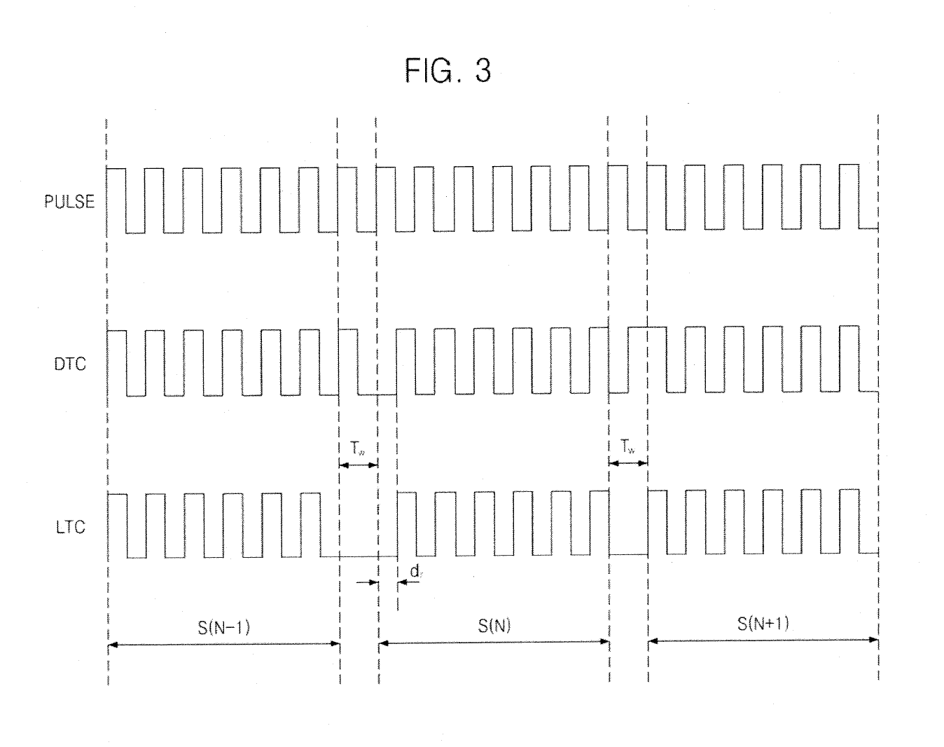

FIG. 1 is a diagram illustrating a depth estimation device according to an example embodiment, and FIG. 2 is a block diagram illustrating a timing controller illustrated in FIG. 1. FIG. 3 is a timing diagram illustrating a waveform of an optical emission control signal LTC and a waveform of an optical detection control signal DTC illustrated in FIG. 2. Referring to FIGS. 1 to 3, a depth estimation device 10 includes a timing controller 20, an optical module 40, a depth sensor 30 and a lens 34.

The timing controller 20 may control the operation the depth sensor 30 and the optical module 40. For example, the timing controller 20 transmits an optical emission control signal LTC to the optical module 40 and transmits an optical detection control signal DTC to the depth sensor 30. The optical module 40 emits an optical signal EL based on an optical emission control signal LTC to an object 50. A reflected optical signal RL, reflected by the object 50, is incident to the depth sensor 30 through the lens 34. According to at least one example embodiment, a depth estimation device 10 may estimate a depth by using an equation 1 displaying a time difference (t_{Δ}) between an emission time of the optical signal EL and an incident time of the reflected optical signal RL.

$${t}_{Δ} = \frac{2 d}{c} \qquad [ Equation 1 ]$$

In equation 1, d indicates a depth between the depth estimation device 10 and the object 50, and c indicates an optical speed.

According to at least one example embodiment, the depth sensor 30 may be included in a chip and calculate depth information. In addition, the depth sensor 30 may estimate three dimensional image information and depth information simultaneously by being used together with a color image sensor chip. According to at least one example embodiment, a depth pixel for detecting depth information in a three-dimensional image sensor and color pixels for detecting image information may be used with a sensing array.

Referring to FIGS. 2 and 3, the timing controller 20 includes a pulse generator 21, a phase delay unit 22, a random number generator 25 and a pulse delay unit 23.

Referring to FIGS. 2 and 3, a pulse PULSE generated in the pulse generator 21 is transmitted to a phase delay unit 22. A random number Li generated in the random number generator 25 is transmitted to the phase delay unit 22. The phase delay unit 22 divides an input pulse PULSE into a plurality of sequences S(N−1), S(N) and S(N+1) and delays a part of the pulse dᵣ so that each sequence S(N−1), S(N), S(N+1) may have different phase differences based on the input random number Li. An optical detection control signal DTC, using a pulse type output from the phase delay unit 22, is output to the depth sensor 30. In addition, the optical detection control signal DTC is transmitted to the pulse delay unit 23. Based on the optical detection control signal DTC the pulse delay unit 23 generates an optical emission control signal LTC having a delay time T_{w} per interval between two adjacent sequences S(N−1), S(N) and S(N+1). The pulse delay unit 23 may filter a pulse signal or use a suppressor. The optical emission control signal LTC is output to an optical module 40.

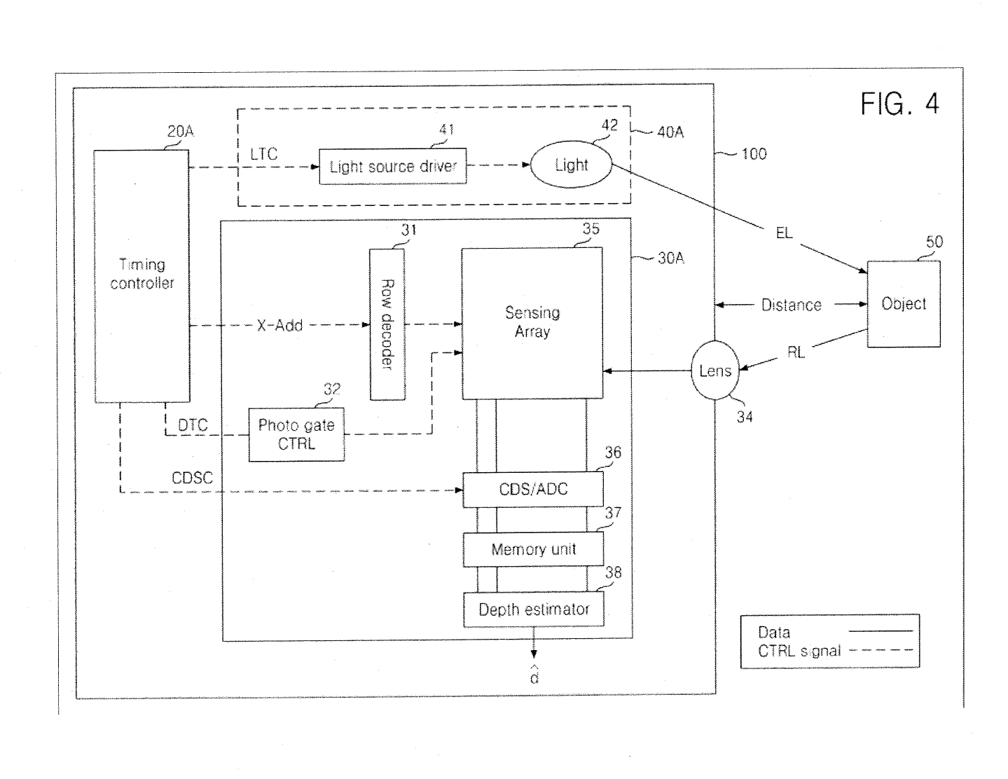

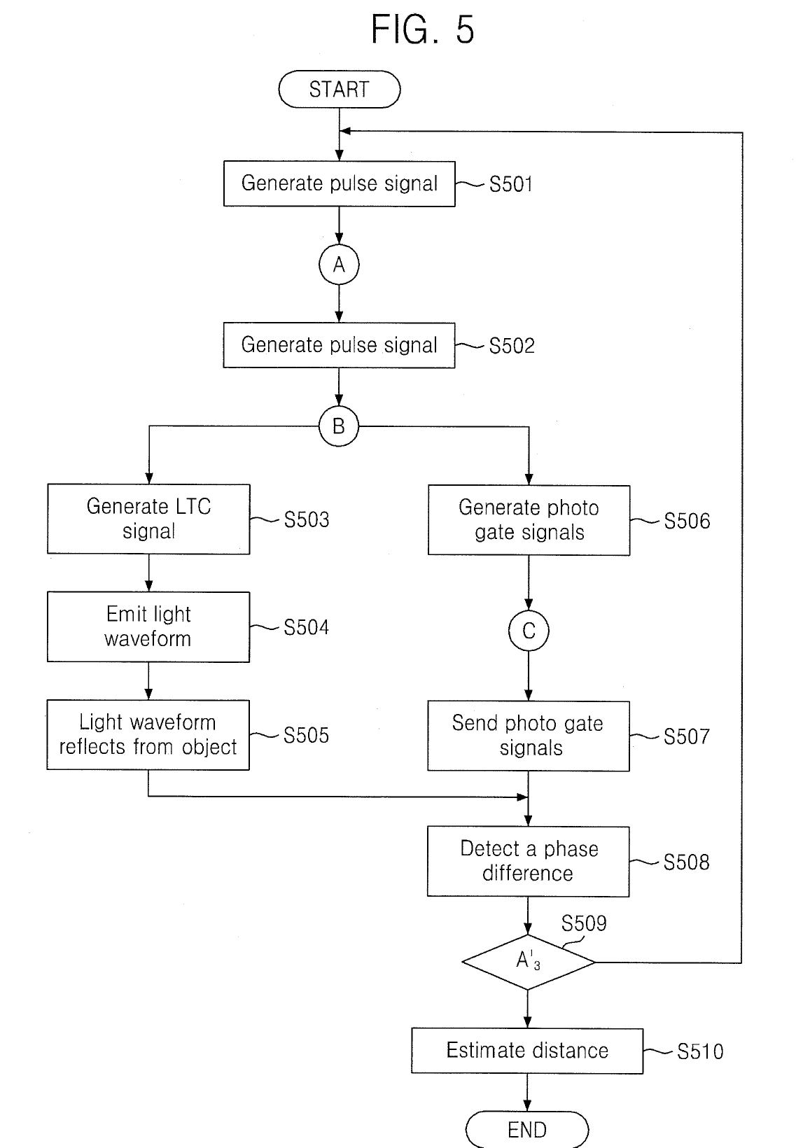

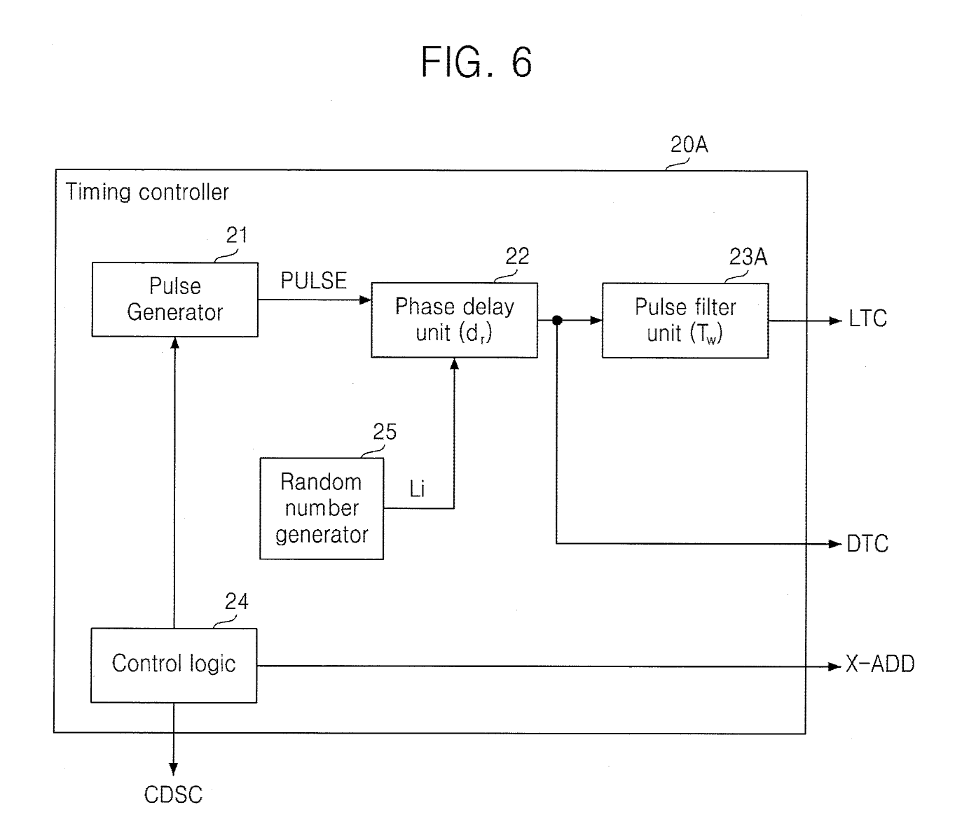

FIG. 4 is a block diagram illustrating a depth estimation device according to at least one other example embodiment, and FIG. 5 is a flowchart illustrating an operation method of the depth estimation device illustrated in FIGS. 1 and 4. FIG. 6 is a block diagram illustrating an example embodiment of a timing controller illustrated in FIG. 4.

Referring to FIG. 4, a depth estimation device 100 includes a timing controller 20A, a depth sensor 30A, an optical module 40A and a lens 34. Referring to FIG. 6, the timing controller 20A illustrated in FIG. 4 includes a control logic 24, a pulse generator 21, a phase delay unit 22, a random number generator 25 and a pulse filter unit 23A. The control logic 24 controls a pulse generator 21, and may transmit a row address X-ADD to a row decoder 31 or transmit a CDS control signal CDSC to a correlated double sampling (CDS)/analog to digital converting (ADC) circuit 36.

Referring to FIGS. 3, 5 and 6, a pulse generator 21 of the timing controller 20A generates a pulse signal PULSE (S501). A phase delay unit 22 has a part of a pulse dᵣ delayed based on a random number Li generated by the random number generator 25 so that there may be a different phase difference per sequence S(N−1), S(N) and S(N+1) (S502). An optical detection control signal DTC generated in the phase delay unit 22 is transmitted to a photo gate controller 32.

A pulse filter unit 23A generates an optical emission control signal LTC by placing each delay time T_{w} between every adjacent sequence S(N−1), S(N) and S(N+1) once receiving a pulse signal having the same waveform as an optical detection control signal DTC output from the phase delay unit 22 (S503). The optical emission control signal LTC is transmitted to an optical source driver 41.

Referring to FIGS. 4 and 5 again, an optical module 40A includes the optical source driver 41 and a light source 42. The optical source driver 41 may generate a clock signal which may drive the light source 42 based on an optical emission control signal LTC output from the timing controller 20A. The light source 42 emits an optical signal EL to an object 50 in response to the clock signal (S504). The light source 42 may be a light emitting diode (LED), an organic light diode (OLED), an active-matrix organic light emitting diode (AMOLED) or a laser diode, etc. For convenience of explanation, a waveform of an optical signal EL may be a sinusoidal wave or a square wave and is assumed to be the same as a waveform of an optical emission control signal LTC.

A reflected optical signal RL is incident to a sensing array 35 through a lens 34 (S505). According to example embodiments, the lens 34 may include a lens and an infrared filter. A depth sensor 30A converts and outputs a reflected optical signal RL into an electric signal. The depth sensor 30A includes a photo gate controller 32, a row decoder 31, the sensing array 35, the CDS/ADC circuit 36, a memory unit 37 and a depth estimator 38.

Still referring to FIGS. 4 and 5, the row decoder 31 selects one of a plurality of rows in response to a row address X-ADD output from the timing controller 20A. In example embodiments, a row indicates an assembly of a plurality of depth pixels laid-out in a horizontal direction in the sensing array 35. The photo gate controller 32 generates gates signals G0 to G3 based on an optical detection control signal DTC transmitted from the timing controller 20A (S506). In addition, the photo gate controller 32 may supply the gate signals G0 to G3 to the sensing array 35, successively (S507).

According to at least one example embodiment, the sensing array 35 includes a plurality of depth pixels. The plurality of depth pixels included in the sensing array 35 detects a phase difference between a reflected optical signal RL and an optical signal EL in response to a plurality of reflected optical signals RL incident to the sensing array 35 through a lens 34 (S508). Accordingly, the sensing array 35 may output an image pixel signal based on incident reflected optical signals RL. In example embodiments, a plurality of stages S501 to S508 are repeated until an output image pixel signal becomes a fourth image pixel signal A′3(S509). According to an example embodiment, at least one of the plurality of stages S501 to S508 may be repeated.

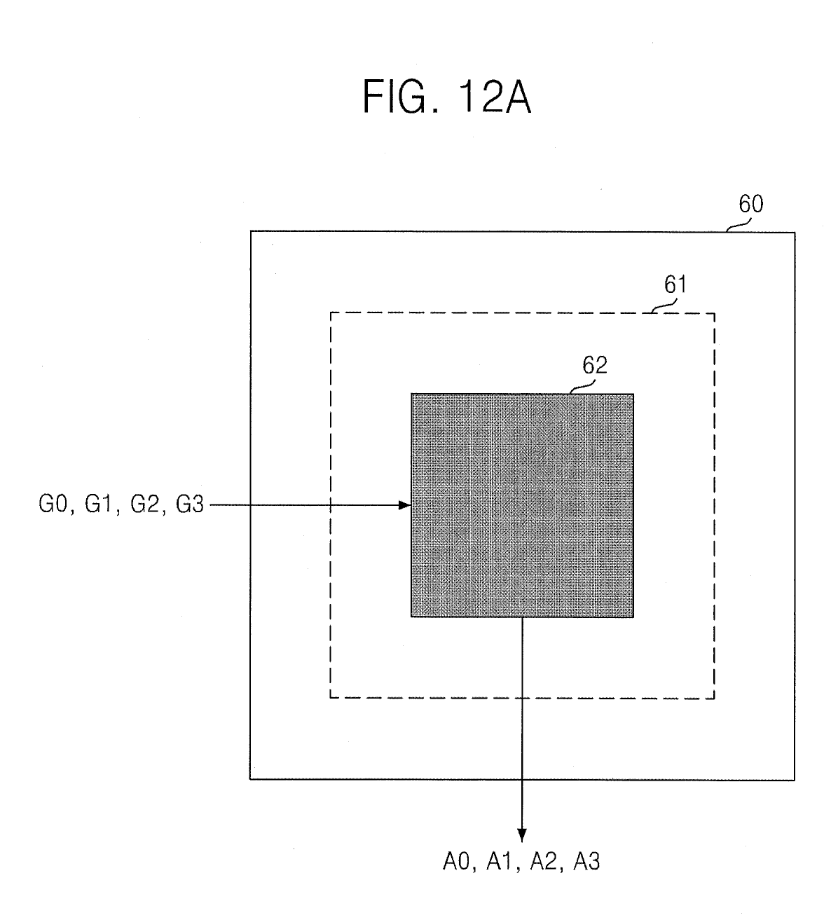

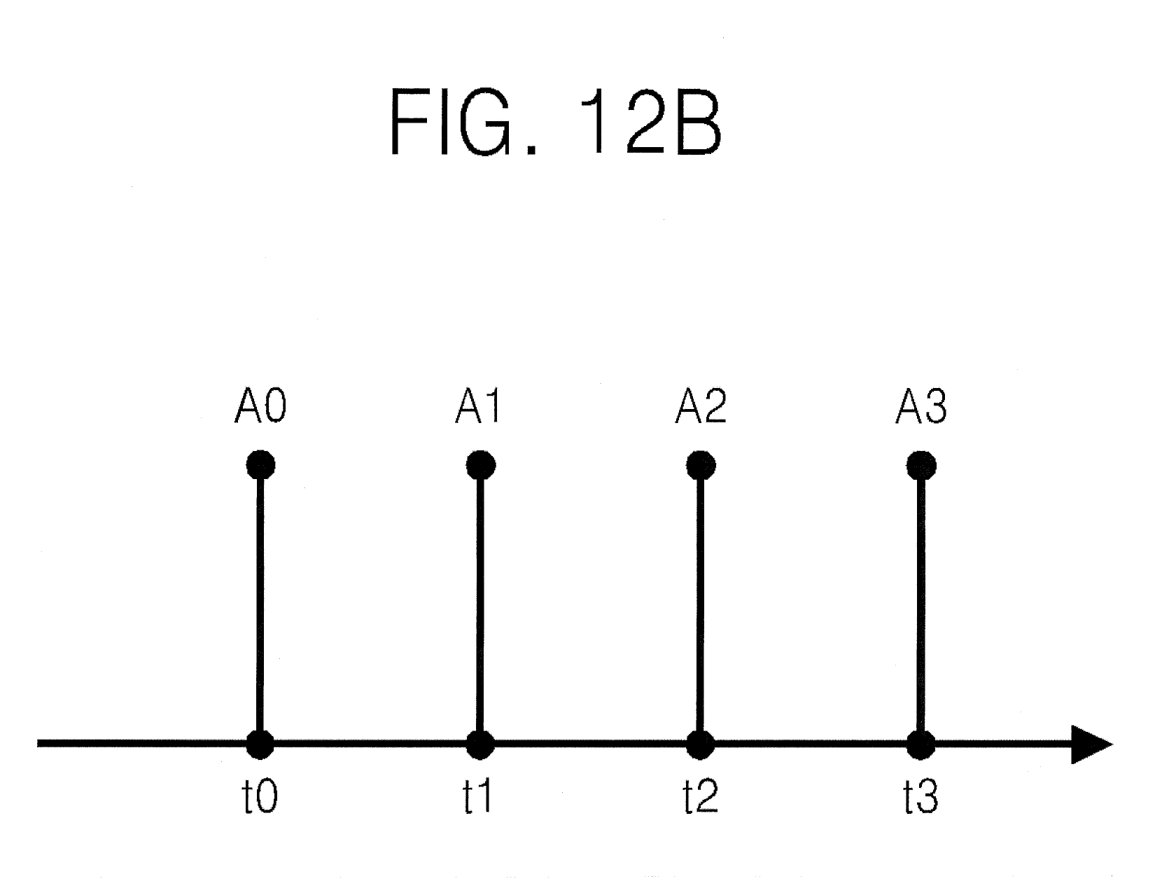

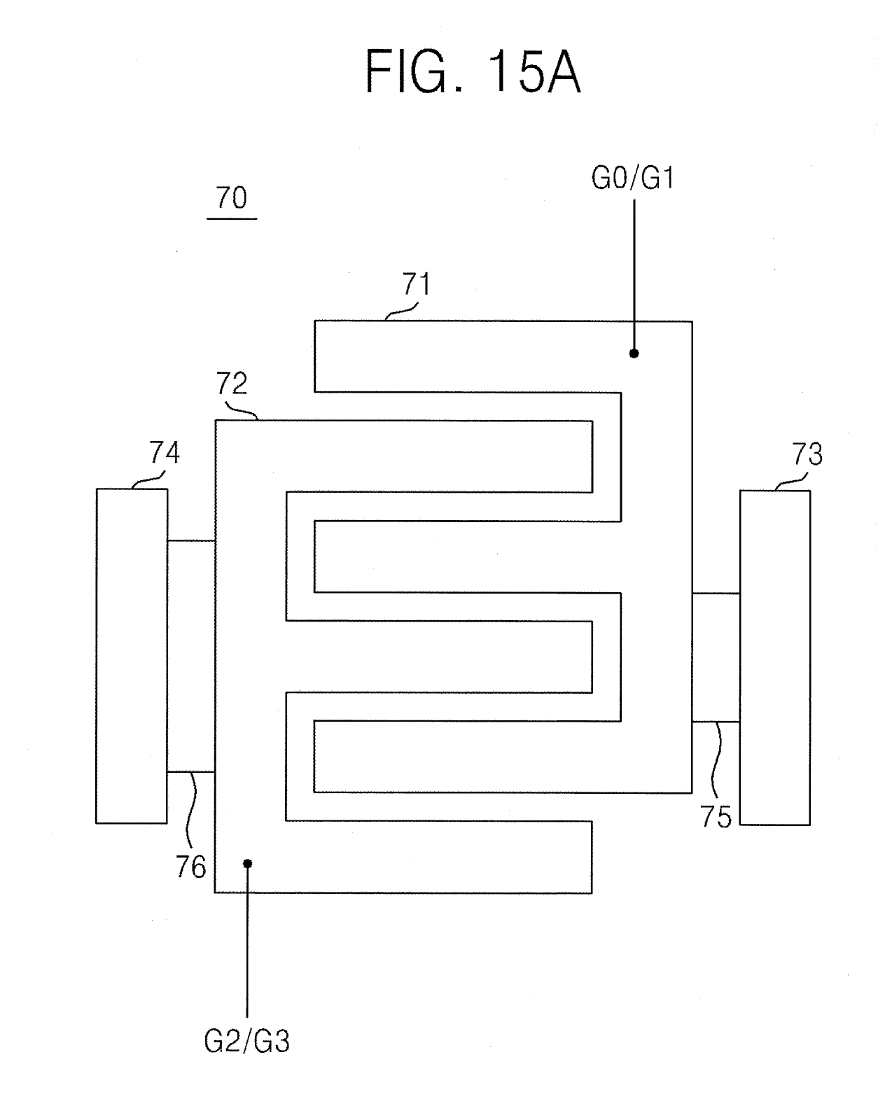

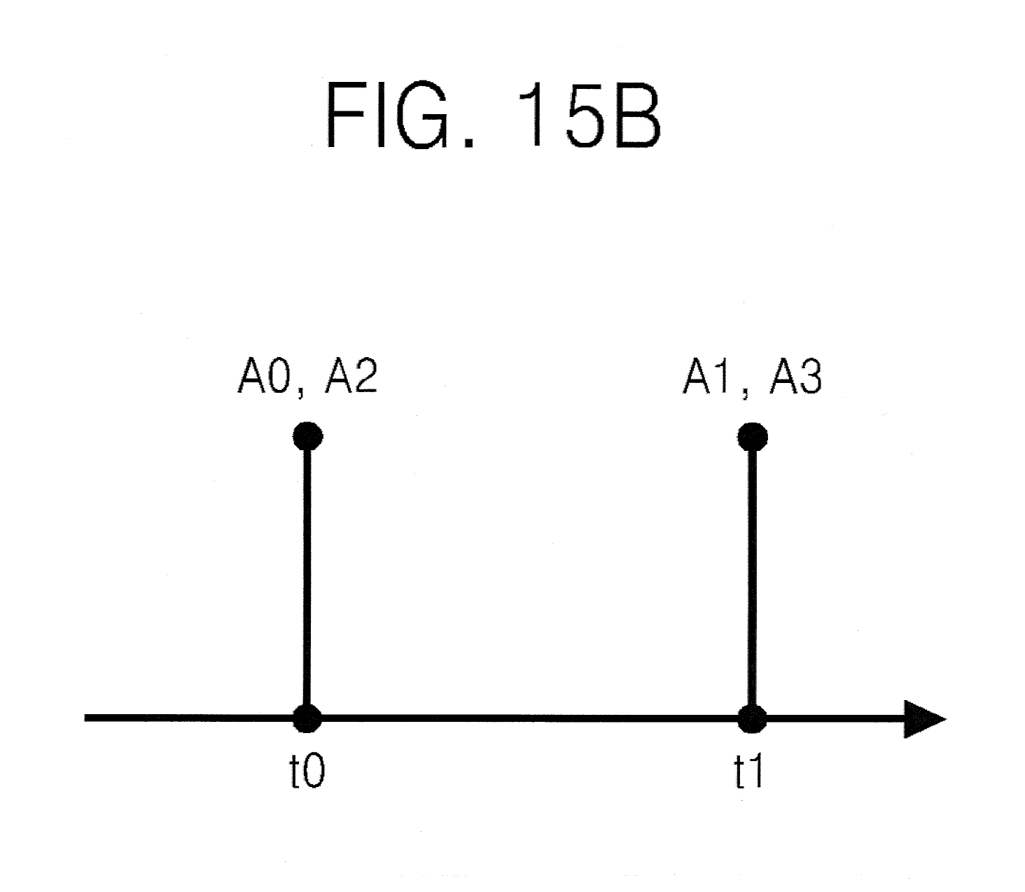

A CDS/ADC circuit 36 performs a correlated double sampling (CDS) operation and an analog to digital converting (ADC) operation on an image pixel signal output from each of a plurality of depth pixels. A CDS/ADC circuit 36 performs the above operations based on a CDS control signal CDSC output from the timing controller 20A, and then outputs digital pixel signals A₀ to A₃. The digital pixel signals A₀ to A₃ are explained in FIGS. 12B and 15B.

A memory unit 37 which may include a buffer may store digital pixel signals A₀ to A₃ output from the CDS/ADC circuit 36 by frame.

The depth estimator 38 estimates a phase difference (\hat{θ}) based on each of the digital pixel signals A₀ to A₃ output from the memory unit 37. A phase difference (\hat{θ}) estimated by the depth estimator 38 is the same as an equation 2.

$$\hat{θ} = 2 π {f}_{m} {t}_{Δ} = {tan}^{- 1} \frac{{A}_{1} - {A}_{3}}{{A}_{0} - {A}_{2}} \qquad [ Equation 2 ]$$

The depth estimator 38 estimates depth information according to an equation 3 by using the phase difference (\hat{θ}) estimated according to the equation 2 and outputs measured depth information (\hat{d})

$$\hat{d} = \frac{c}{4 π {f}_{m}} \hat{θ} \qquad [ Equation 3 ]$$

Here, c indicates a light speed and fₘ indicates a frequency.

According to at least one example embodiment, a depth sensor 30A may include a type of a charge coupled device (CCD) or a CMOS image sensor (CIS). If the depth sensor 30A includes a CIS, a structure of FIG. 4 may be applied. When the depth sensor 30A is a CCD, a structure of the CDS/ADC 36 may be partially changed.

An ADC may change its structure depending on whether an analog CDS, a digital CDS or a dual CDS mode is used. Moreover, the ADC may include a column ADC laid out by columns of the depth sensor 30A or a single ADC where a single ADC is laid out.

The depth sensor 30A may be included in the timing controller 20A and a chip. In addition, the depth sensor 30A, the timing controller 20A and the lens 34 may consist of a module and an optical module 40A may consist of another module.

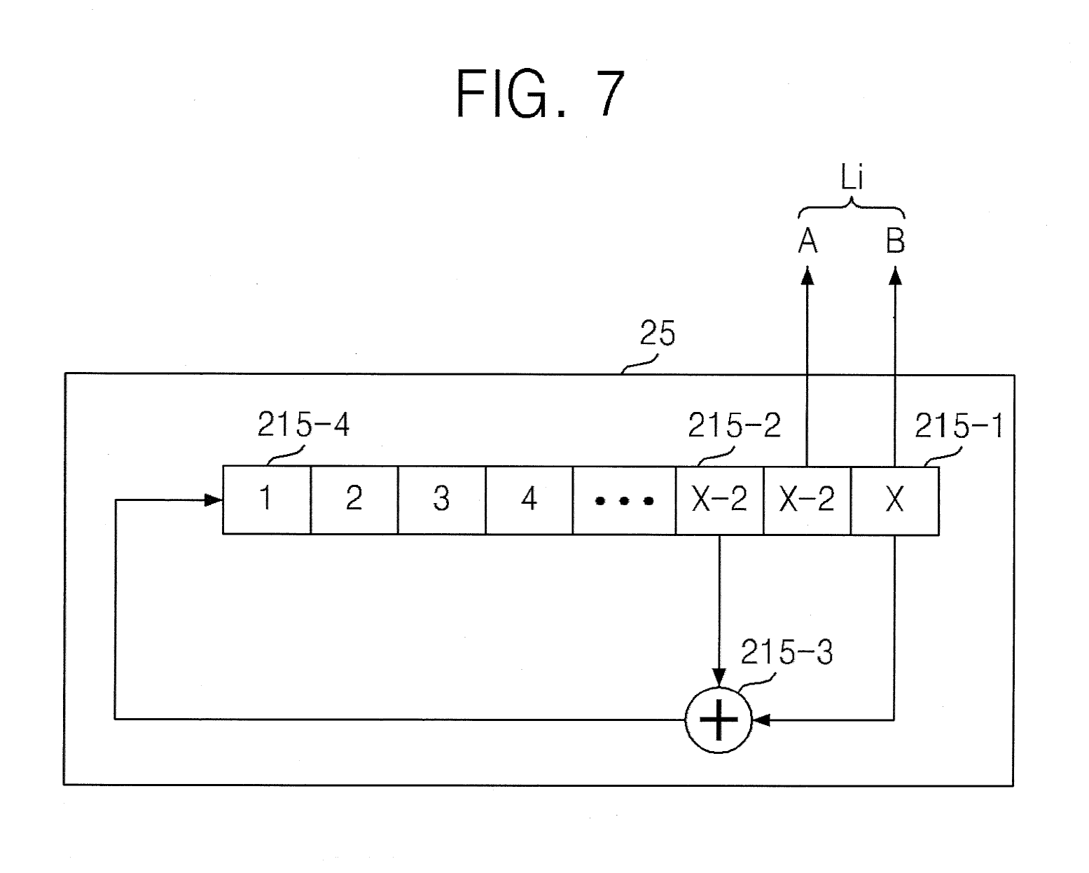

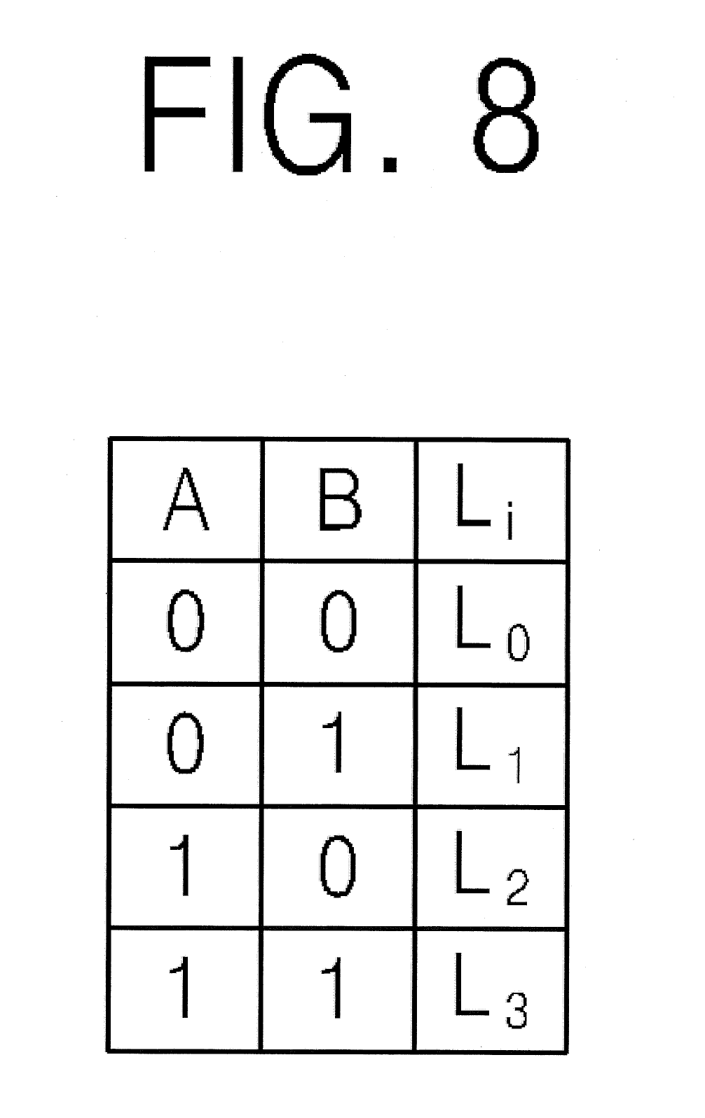

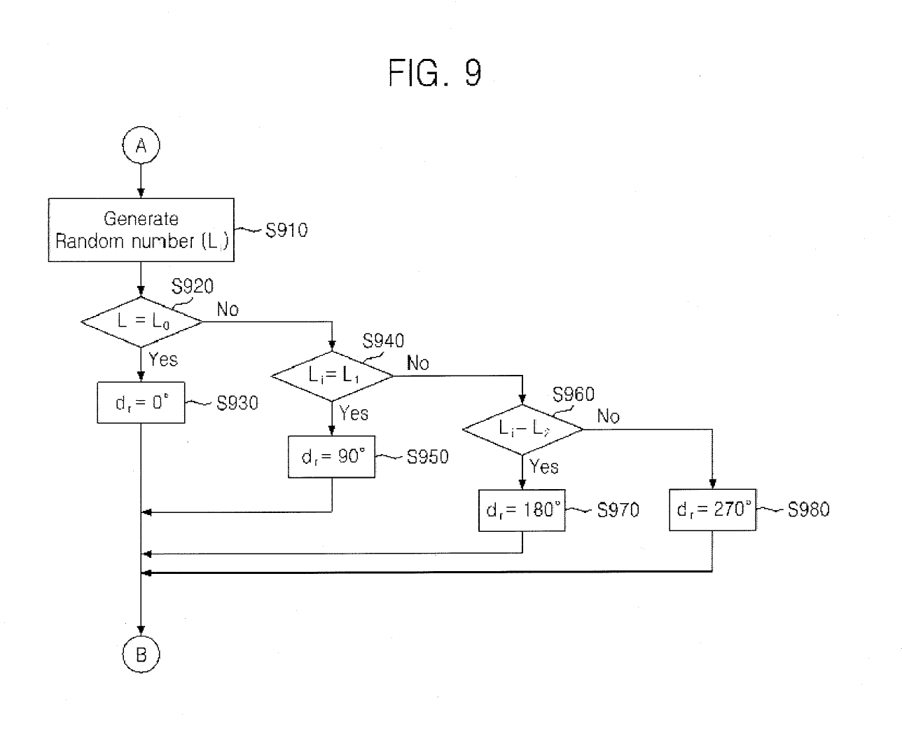

FIG. 7 is a block diagram illustrating an example embodiment of the random number generator illustrated in FIG. 6, and FIG. 8 displays a truth table of the random number generator illustrated in FIG. 6. FIG. 9 is a flowchart illustrating an operation of the random number generator in the flowchart of FIG. 5.

The random number generator may include a linear feedback shift register (LFSR) having X(X is an integer more than 2) shift registers. LFSR is configured such that values input to shift registers are calculated using a linear function of its previous state values. The LFSR may be implemented with, for example, a Fibonacci configuration or Galois configuration. In example embodiments, a linear function used in the LFSR may be exclusive OR. Referring to FIG. 7, the random generator 25 includes X (X is an integer more than 2) registers 1˜X. An OR gate 215-3 performs an exclusive OR operation on output signals of registers 215-1 and 215-2, and outputs a result to a first terminal of a register 215-4. Accordingly, the random number generator 25 may output a plurality of bits A and B composing a random number L.

Referring to FIG. 8, a phase designated signal Lᵢ is generated based on a truth table of the bits A and B output from the random generator 25. For example, when the bits A and B output from the random generator 25 are 00, 01, 10 or 11, the phase designated signal Lᵢ is a first phase designated signal L₀, a second phase designated signal L₁, a third phase designated signal L₂ or a fourth phase designated signal L₃.

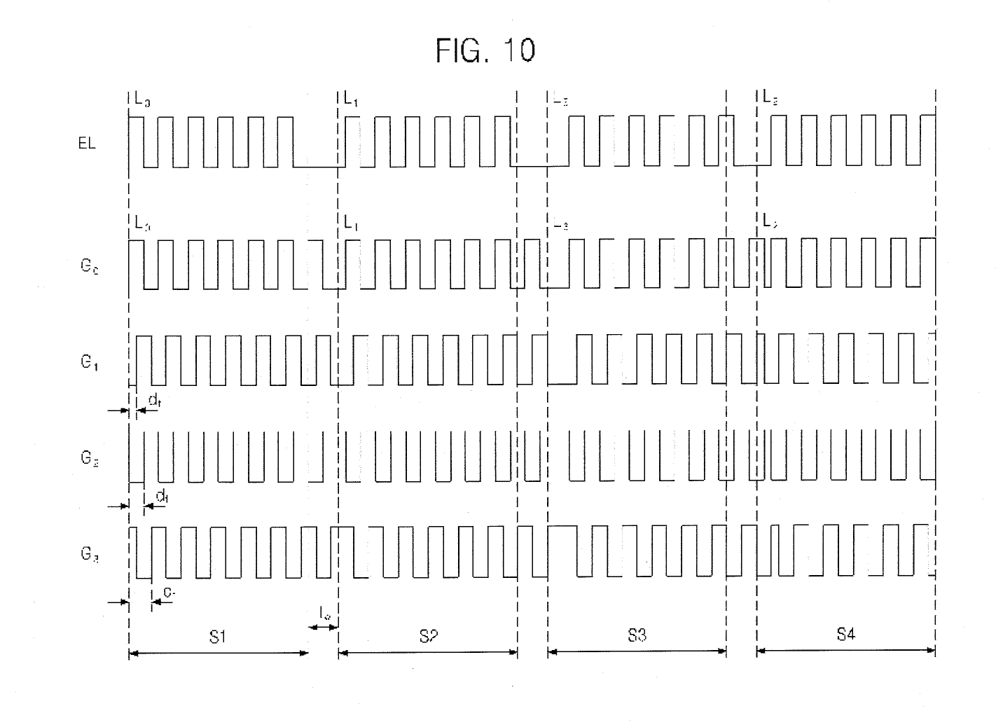

FIG. 10 is a timing diagram illustrating a waveform of an optical signal EL from FIG. 4 and a waveform of a first gate signal through a fourth gate signal. Referring to FIGS. 6, 9 and 10, the random number generator 25 included in the timing controller 20A generates a phase designated signal Lᵢ, which is generated randomly (S910). The phase designated signal Lᵢ may be transmitted to the phase delay unit 22 and control each phase of a plurality of sequences.

For example, the phase delay unit 22 may generate a waveform of a sequence having a waveform of an original pulse based on a first phase designated signal L₀ (S920 and S930), or generate a waveform of a sequence, which has a phase difference of 90° compared to a waveform of an original pulse, based on a second phase designated signal L₁ (S940 and S950). The phase delay unit 22 may also generate a waveform of a sequence, which has a phase difference of 180° compared to a waveform of an original pulse, based on a third phase designated signal L₂ (S960 and S970), or generate a waveform of a sequence, which has a phase difference of 270° compared to a waveform of an original pulse, based on a fourth phase designated signal L₃ (S980).

For convenience of explanation, a waveform of an optical signal EL is assumed to be the same as a waveform of an optical emission control signal LTC of FIG. 3, but is not limited thereto. Referring to FIG. 10, the optical signal EL includes a plurality of sequences S1 to S4 and has a delay time T_{w} between the sequences S1 to S4. A phase difference between the plurality of sequences S1 to S4 may be one of 0°, 90°, 180° and 270°. The optical signal EL may be a sine wave or a square wave.

According to at least one example embodiment, a first gate signal to a fourth gate signal G₀ to G₃ are output to the sensing array 35 in the photo gate controller 32. Each gate signal G₀ to G₃ includes a plurality of sequences S1 to S4, each gate signal having a different phase difference compared to a waveform of the optical signal EL. Here, a phase of the optical signal EL and a phase of the first gate signal G₀ are identical. Additionally, a phase difference between the first gate signal G₀ and a second gate signal G₁ is 90°, a phase difference between the first gate signal G₀ and a third gate signal G₂ is 180°, and a phase difference between the first gate signal G₀ and a fourth gate signal G₃ is 270°. Unlike the optical signal EL, gate signals G₀ to G₃ may not include a delay time T_{w}.

According to at least one example embodiment, there is a time interval between when an optical signal EL output from a light source 42 is reflected by the object 50 and when it is incident to the lens 34. For example, a first sequence S1 has a first phase designated signal L₀ and a second sequence S2 has a second phase designated signal L₁, so that a phase difference between the two sequences is 90°. Without delay time T_{w} in the optical signal EL, a first sequence S1 of a reflected optical signal RL and a second sequence S2 of a gate signal G₀ are synchronized, which may cause error when estimating a depth. According to at least one example embodiment, however, a delay time T_{w} of the optical signal EL may be omitted if a numerical value of this error is minimal enough to be ignored.

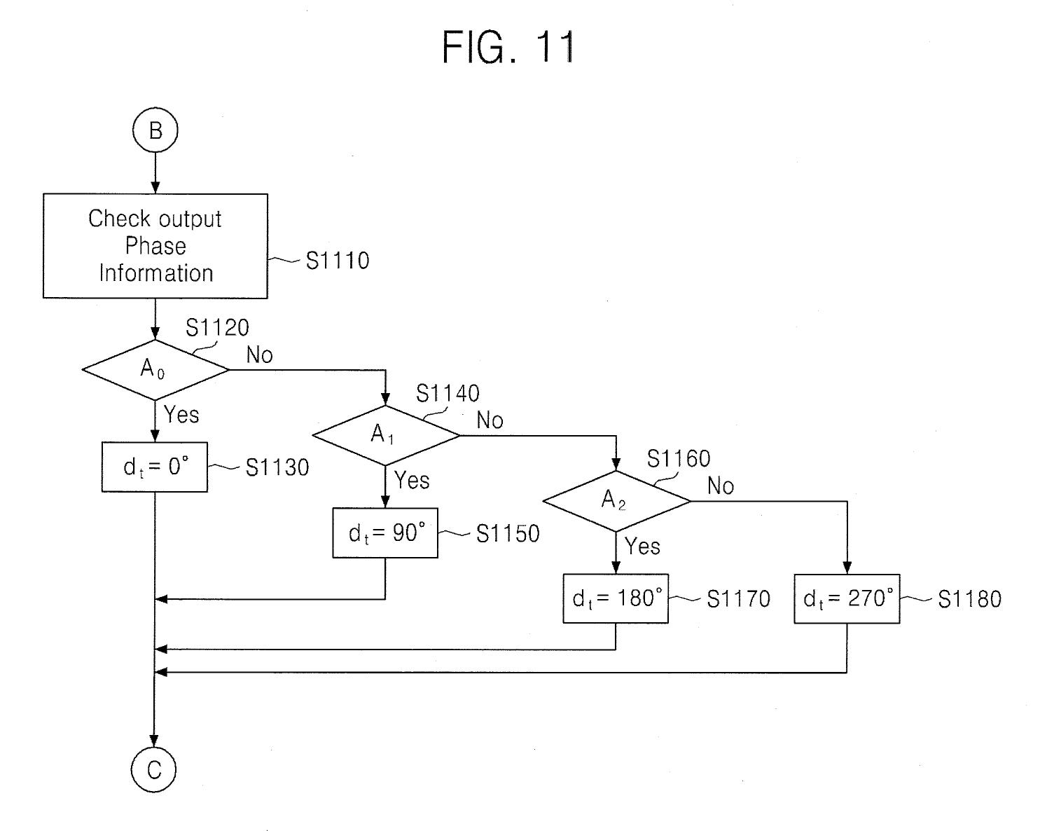

According to at least one example embodiment, the sensing array 35 illustrated in FIG. 4 may include a depth pixel of one-tap pixel structure. FIGS. 11 to 14 are drawings explaining a structure and an operation of the one-tap depth pixel.

FIG. 11 is a sectional flowchart illustrating an operation of the photo gate controller 32 transmitting a gate signal to the one-tap depth pixel illustrated in FIG. 4 from the flowchart in FIG. 5. Referring to FIGS. 5, 10 and 11, the photo gate controller 32 checks output phase information of an image pixel signal for sensing a depth (S1110).

When the output phase information of the checked image pixel signal outputs a first image pixel signal A₀, the photo gate controller 32 outputs a first gate signal G₀ having an identical phase with an optical signal EL to the sensing array 35 (S1120 and S1130). When the output phase information of the checked image pixel signal outputs a second image pixel signal A₁, the photo gate controller 32 outputs a second gate signal G₁ having a phase difference of 90° from the optical signal EL to the sensing array 35 (S1140 and S1150). When the output phase information of the checked image pixel signal outputs a third image pixel signal A₂, the photo gate controller 32 outputs a third gate signal G₂ having a phase difference of 180° from the optical signal EL to the sensing array 35 (S1160 and S1170). Otherwise, when the output phase information of the checked image pixel signal outputs a fourth image pixel signal A₃, the photo gate controller 32 outputs a fourth gate signal G₃ having a phase difference of 270° from the optical signal EL to the sensing array 35 (S1180).

FIG. 12A displays a layout of a depth pixel having a one-tap pixel structure included in a sensing array illustrated in FIG. 4, and FIG. 12b is a timing diagram of pixel signals detected in a depth pixel having the one-tap pixel structure illustrated in FIG. 12 and a phase difference.

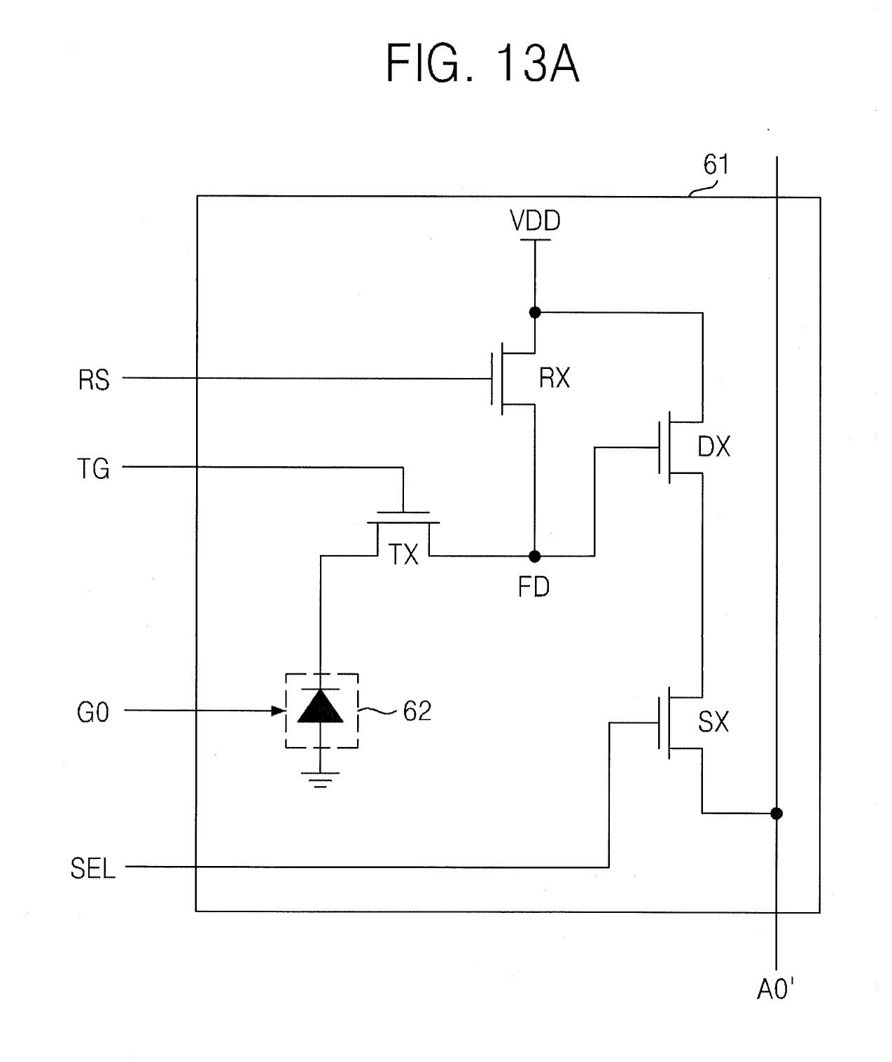

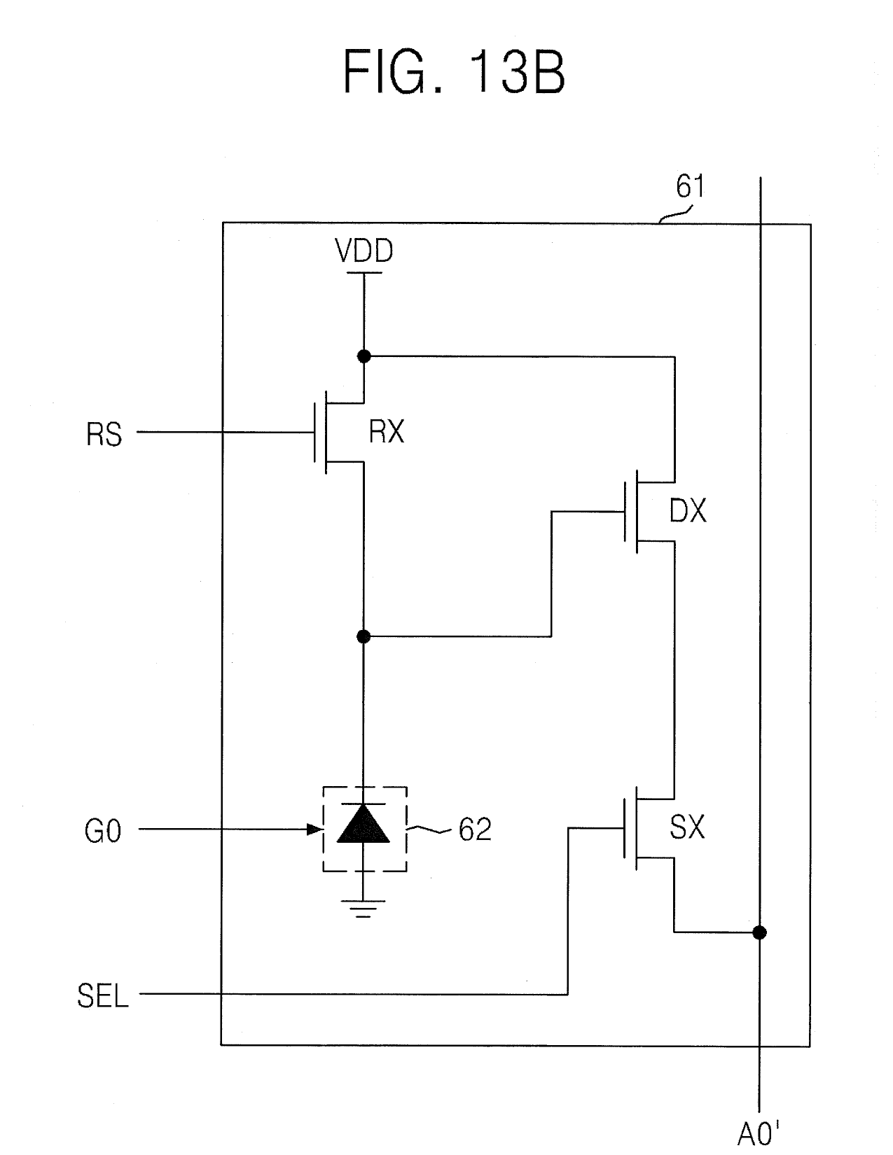

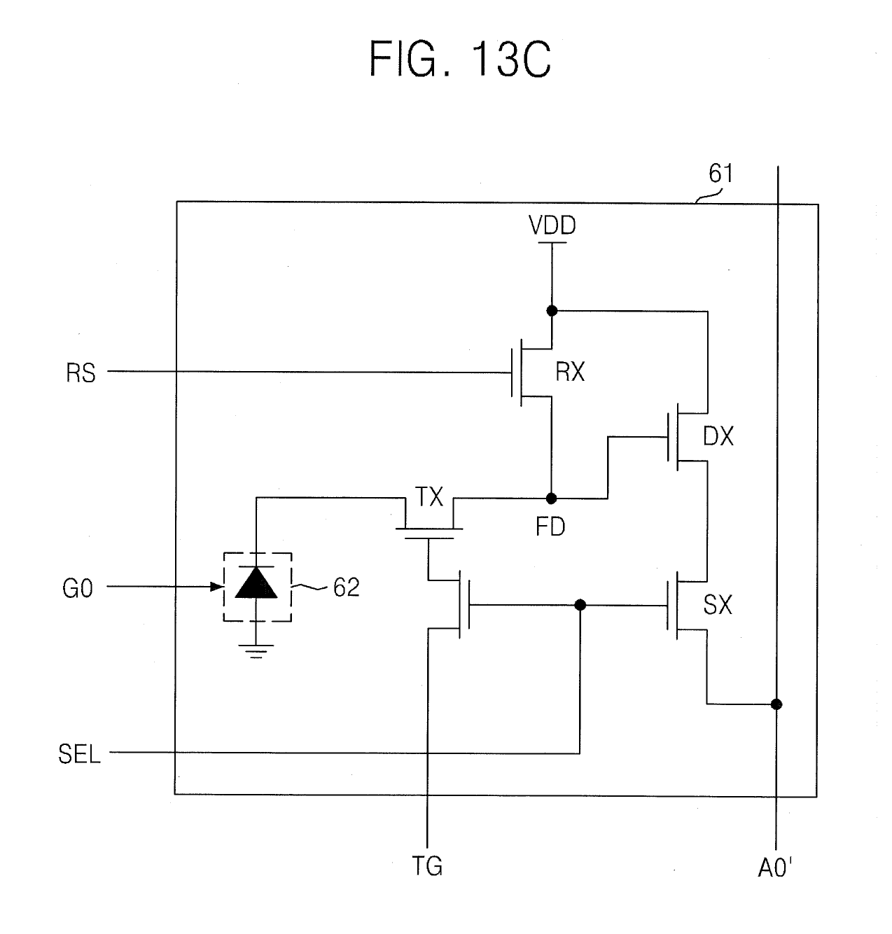

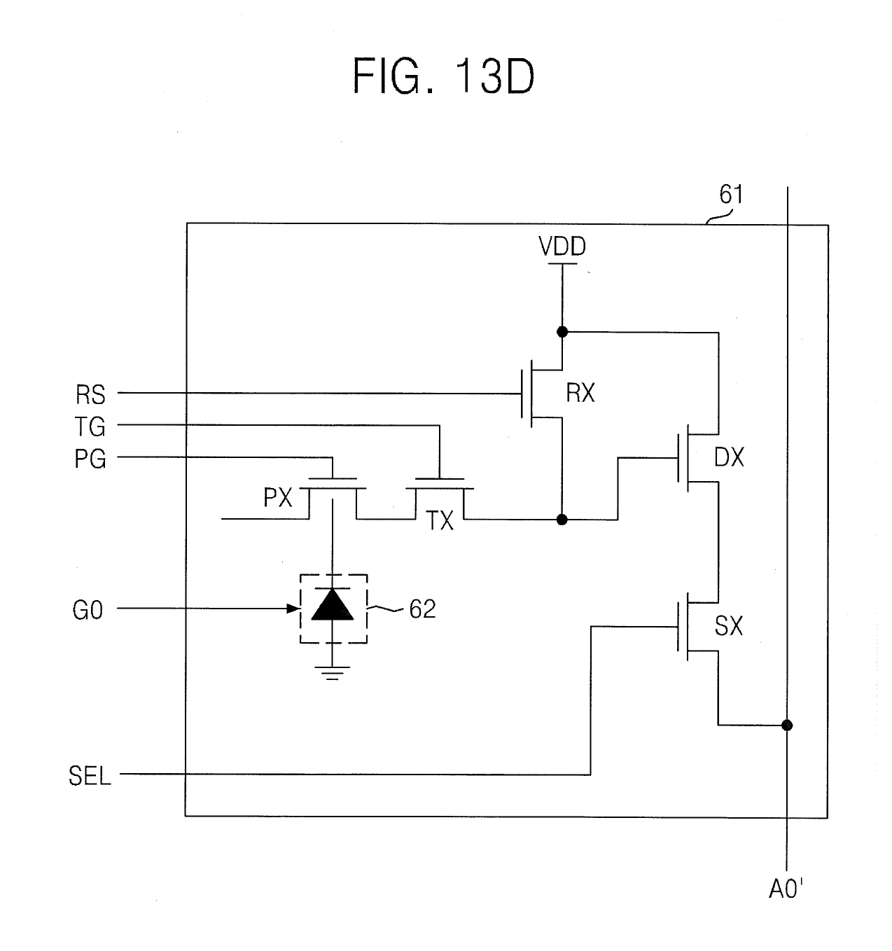

A depth pixel 60 having a one-tap pixel structure includes a photoelectric conversion element 62 included in an active region 61. The photoelectric conversion element 62 and T transistors are included in the active region 61 as illustrated in FIGS. 13a to 13d, respectively. In at least one example embodiment, T may be 3, 4 or 5 or another natural number. As illustrated in FIG. 12a, each gate signal G0 to G3 having a phase difference of 0°, 90°, 180° or 270° is applied to the photoelectric conversion element 62, successively.

According to at least one example embodiment, the photoelectric conversion element 62 performs a photoelectric conversion operation according to a reflected light RL while each gate signal G0 to G3 has a high level. Optical charges generated by the photoelectric conversion element 62 are transmitted to a floating diffusion node FD (shown in, for example, FIG. 13A).

Referring to FIGS. 12A and 12B, a depth pixel 60 having a one-tap pixel structure outputs a first digital pixel signal A0 in response to a first gate signal G0 having a phase difference of 0° at a first time point t0, outputs a second digital pixel signal A1 in response to a second gate signal G1 having a phase difference of 90° at a second time point t1, outputs a third digital pixel signal G2 in response to a third gate signal A2 having a phase difference of 180° at a third time point t2, and outputs a fourth digital pixel signal A3 in response to a fourth gate signal G3 having a phase difference of 270° at a fourth time point t3.

FIGS. 13A to 13D are various circuits illustrating a photoelectric conversion element and transistors included in the active region 61 from FIG. 12A. As illustrated in FIG. 13A, the photoelectric conversion element 62 and four transistors RX, TX, DX and SX are included in the active region 61. Referring to FIG. 13a, the photoelectric conversion element 62 may generate optical charges based on gate signals G0 to G3 (from FIG. 12A) and a reflected light RL. For example, the photoelectric conversion element 62 may be on or off in response to a gate signal GO output from the timing controller 20A. For example, when the gate signal G0 is at a high level, the photoelectric conversion element 62 may generate optical charges based on a reflected light RL, but the photoelectric conversion element 62 does not generate optical charges based on the reflected light when the gate signal G0 is at a low level.

The photoelectric conversion element 62 may include a photo diode, a photo transistor, a photo gate or a pinned photo diode (PPD) as an optical sensing element. A reset transistor RX may reset the floating diffusion region FD in response to a reset signal RS output from the timing controller 20A. A transmission transistor TX may transmit optical charges generated by the photoelectric conversion element 62 to the floating diffusion region FD in response to a control signal TG output from the timing controller 20A.

A drive transistor DX functioning as a source follower buffer amplifier may perform a buffering operation in response to optical charges collected in the floating diffusion region FD. A selection transistor SX may output an image pixel signal A0′ output from a drive transistor DX to a column line in response to a control signal SEL output from the timing controller 20A.

FIG. 13A illustrates the active region 61 including the photoelectric conversion element 62 and four transistors TX, RX, DX and SX, however, this structure is not limited thereto. As illustrated in FIG. 13B, the photoelectric conversion element 62 and three transistors RX, DX and SX may be included in the active region 61. Thus, a transmission transistor TX from FIG. 13A may not be included in the active region 61 of FIG. 13B.

According to example embodiments, as illustrated in FIG. 13C, the photoelectric conversion element 62 and five transistors RX, TX, DX, SX and GX may be included in the active region 61. Referring to FIG. 13C, a control signal TF for controlling an operation of a transmission transistor TX is applied to a gate of the transmission transistor TX through a transistor GX which turns on or off in response to a control signal SEL.

According to example embodiments, as illustrated in FIG. 13D, the photoelectric conversion element 62 and five transistors RX, TX, DX, SX and PX may be included in the active region 61. A transistor PX operates in response to a control signal PG output from the timing controller 20A.

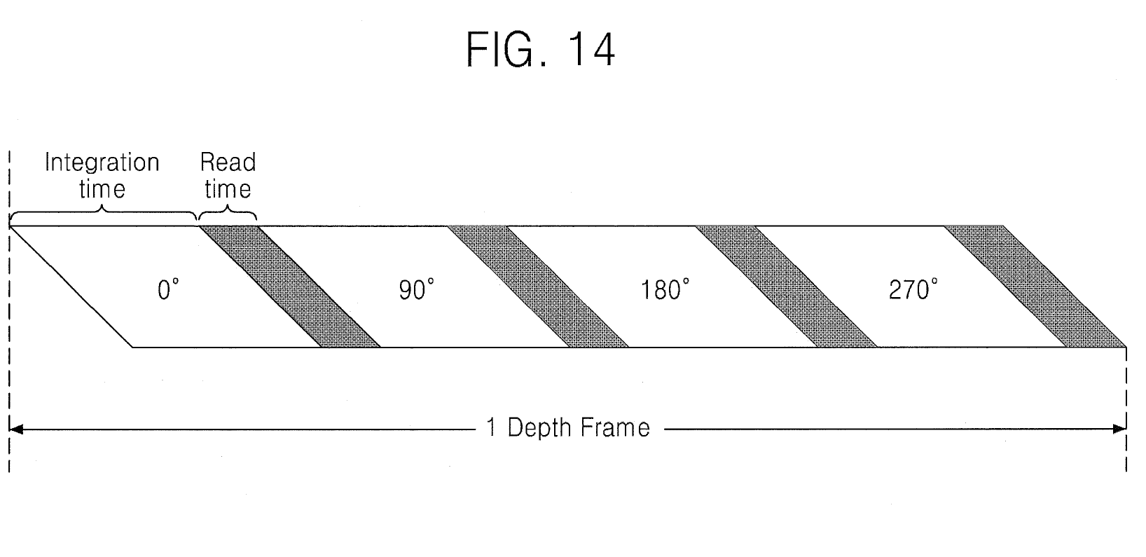

FIG. 14 is a conceptual diagram illustrating a frame performed in a rolling shutter mode in a depth sensor having the one-tap structure illustrated in FIG. 12A. Here, a phase of an optical signal EL from the light source 42 is assumed to be 0°.

Referring to FIG. 14, optical charge accumulation based on a gate signal G1 having a phase of 90° is started on rows where a read operation is finished even while a read operation based on a gate signal G0 having a phase of 0° is performed on a frame. A similar operation occurs when a phase of a gate signal is changed from 90° to 180° or from 180° to 270°.

According to at least one example embodiment, the sensing array 35 illustrated in FIG. 4 may include a depth pixel having a two-tap pixel structure. FIGS. 15A to 18 are illustrate a structure and an operation of a two-tap depth pixel.

FIG. 15A displays a layout of the depth pixel having a two-tap pixel structure, which may be included in the sensing array from FIG. 4, and FIG. 15B is a timing diagram showing a phase difference between pixel signals detected in the depth pixel having two-tap pixel structure illustrated in FIG. 15A and an image pixel signal. A depth pixel 70 having the two-tap pixel structure includes a first photo gate 71, a bridging diffusion region 75 and a transmission transistor (TX1, 73), and includes a second photo gate 72, a bridging diffusion region 76 and a transmission transistor 74.

Referring to FIGS. 15A and 15B, a two-tap depth pixel 70 detects a first digital pixel signal A0 and a third digital pixel signal A2 in response to a first gate signal G0 and a second gate signal G2 at a first time point t0 and detects a second digital pixel signal A1 and a fourth digital pixel signal A3 in response to a third gate signal G1 and a fourth gate signal G3 at a second time point t1.

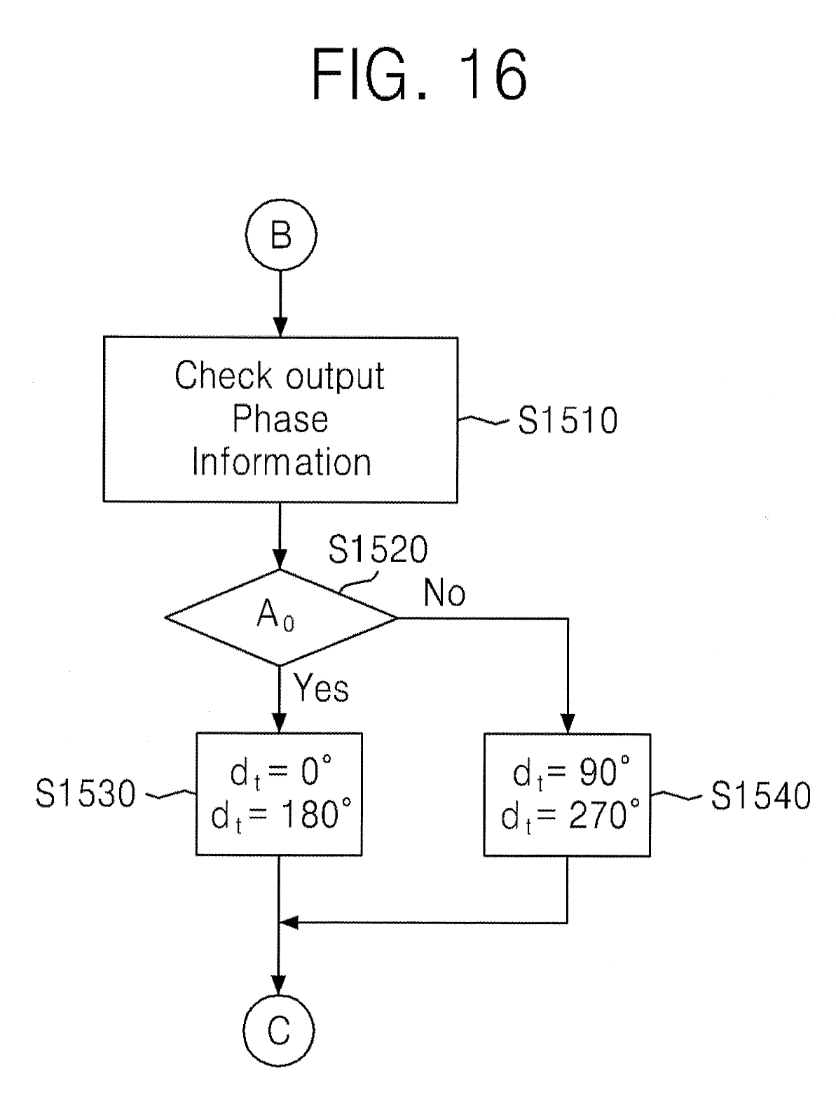

FIG. 16 is a flowchart illustrating an operation of a photo gate controller transmitting a gate signal to the two-tap depth pixel from the flowchart of FIG. 5. Referring to FIGS. 5, 10, 15 and 16, a photo gate controller 32 checks output phase information of an image pixel signal for sensing a depth (S1510).

Here, when the checked output phase information of the image pixel signal outputs a first image pixel signal A₀ (S1520), the photo gate controller 32 outputs a first gate signal G0 having an identical phase with an optical signal EL to a first photo gate 71, and outputs a third gate signal G2 having a phase difference of 180° from the optical signal EL to a second photo gate 72 (S1530). Otherwise, when the checked output state information of the image pixel signal does not output a first image pixel signal A₀, the photo gate controller 32 outputs a second gate signal G1 having a phase difference of 90° from the optical signal EL to a first photo gate 71 of a two-tap pixel signal, and outputs a fourth gate signal G3 having a phase difference of 270° from the optical signal EL to a second photo gate 72 of the two-tap pixel signal (S1540).

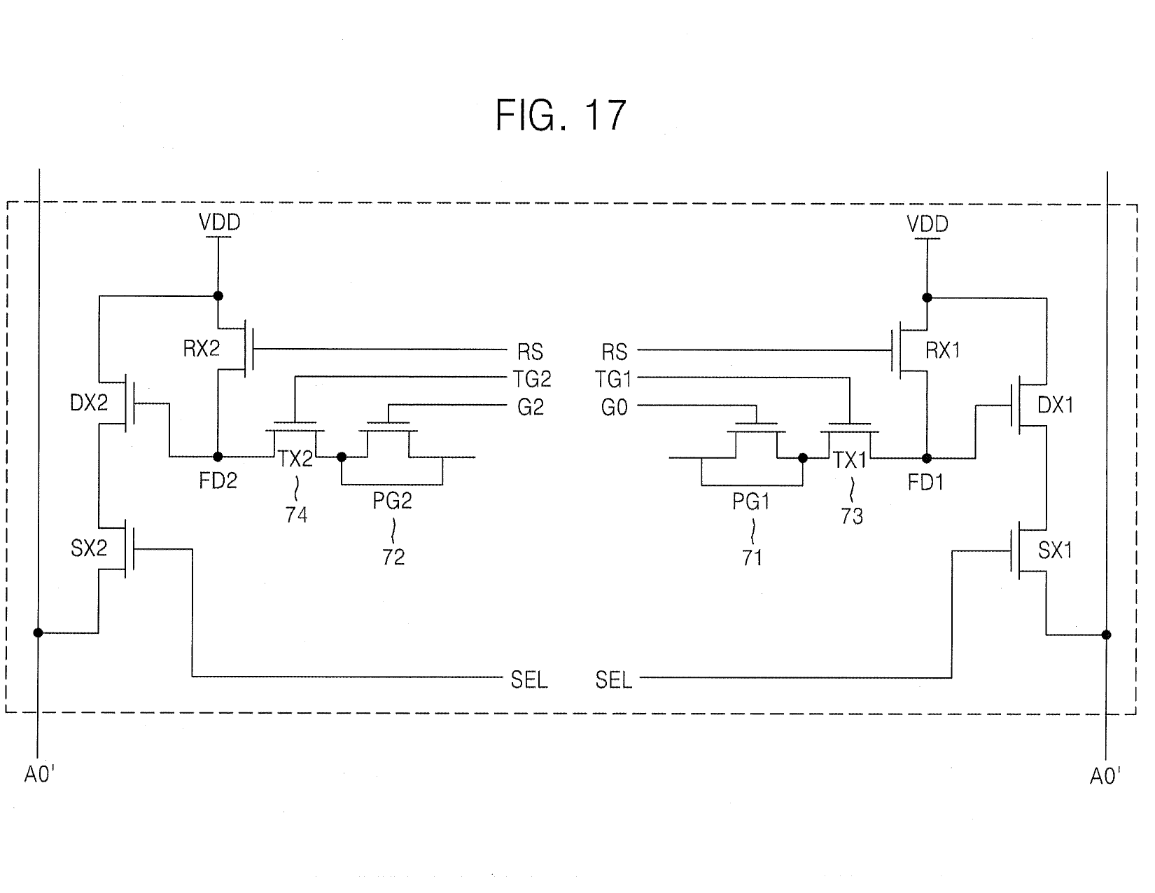

FIG. 17 is a circuit diagram including a plurality of photo gates and a plurality of transistors included in the two-tap depth pixel of FIG. 16a. Referring to FIG. 17, a depth pixel of two-tap configuration includes a first circuit region processing optical charges generated by a reflected light RL passing through a first photo gate (PG1, 71), and a second circuit region processing optical charges generated by a reflected light RL passing through a second photo gate (PG2, 72)

According to at least one example embodiment, the first circuit region includes a first photo gate 71 collecting or transmitting the optical charges and a plurality of transistors TX1, RX1, DX1 and SX1. Further, the second circuit region includes a second photo gate 72 collecting or transmitting the optical charges and a plurality of transistors TX2, RX2, DX2 and SX2.

A first transfer circuit (TX1, 73), which may include a transfer gate, transfers generated optical charges to a first floating diffusion region FD1 in response to a control signal TG1. Optical charges may be transferred by adjusting a voltage level of the control signal TG1, and with proper timing may block diffusion from the first floating diffusion region FD1 to the first photo gate 71. In addition, a second transfer circuit (TX2, 74), which may include a transfer gate, transfers generated optical charges to a second floating diffusion region FD2 in response to a control signal TG2. Optical charges may be transferred by adjusting a voltage level of the control signal TG2, and with proper timing may block diffusion from a second floating diffusion region FD2 to the second photo gate 72.

Still referring to FIG. 17, in response to each of gate signals G0 and G2 output from the photo gate controller 32, each of the first photo gate 71 and the second photo gate 72 may perform a collection operation and collect optical charges generated in a semiconductor substrate by a reflected optical signal RL. The first photo gate 71 and second photo gate 72 may then transfer collected optical charges to each floating diffusion region FD1 or FD2, respectively.

A phase difference between two gate control signals G0 and G2 received in each of the two photo gates 71 and 72 is 180°. However, a phase difference between the optical signal EL and one of the two photo gate control signals may be 0°, 90°, 180° or 270°. Each transfer transistor TX1 or TX2 may transmit optical charges collected at a lower part of each photo gate 71 or 72 to each floating diffusion region FD1 or FD2 in response to each control signals TG1 or TG2 output from the timing controller 20A.

Each drive transistor DX1 or DX2 may function as a source follower buffer amplifier and may perform a buffering operation in response to optical charges charged in each floating diffusion region FD1 or FD2. Each selection transistor SX1 or SX2 may output a signal A0′ or A2′ buffered by each drive transistor DX1 or DX2 to each column line in response to a control signal SEL output from the timing controller 20A.

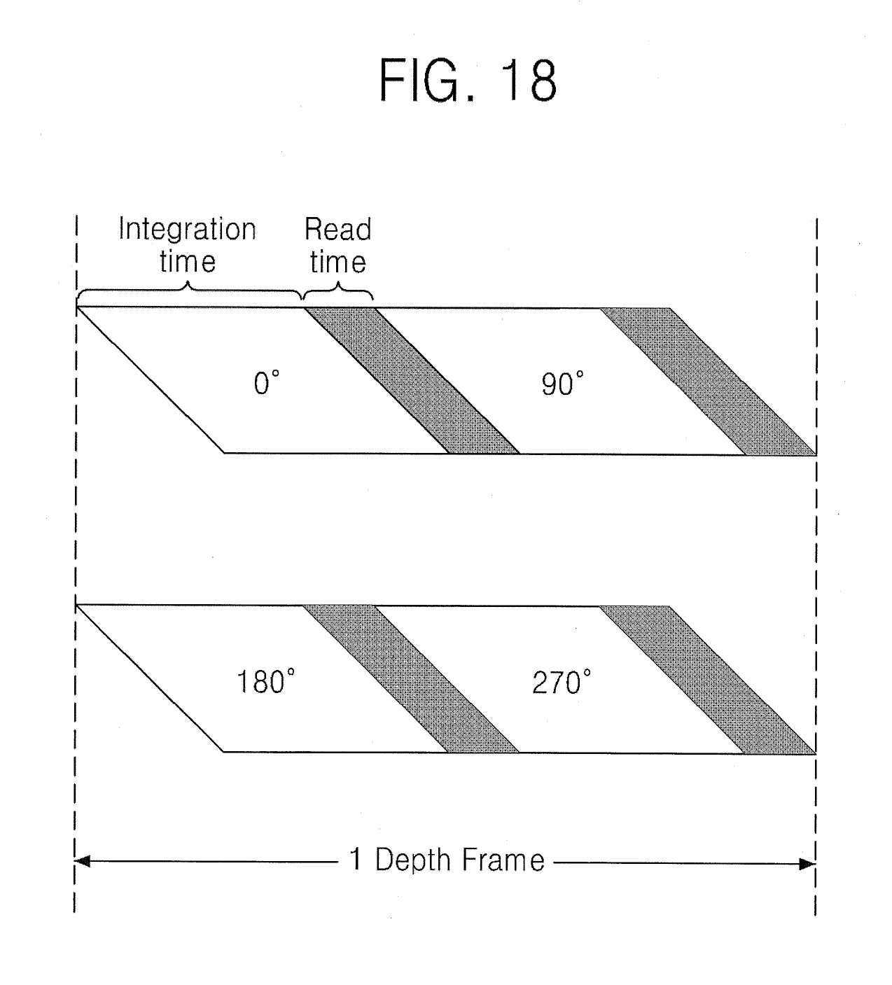

FIG. 18 is a conceptual diagram illustrating a frame performed in a rolling shutter mode in a two-tap pixel depth sensor from FIG. 16A. Here, a phase of an optical signal EL emitted from the light source 42 is assumed to be 0°. Referring to FIG. 18, optical charge accumulation based on each of gate signals G1 and G3 having a phase of 90° and 270° is started on rows where a read operation is finished even while a read operation based on each of the gate signals G0 and G2 having a phase of 0° and 180° for a frame is performed.

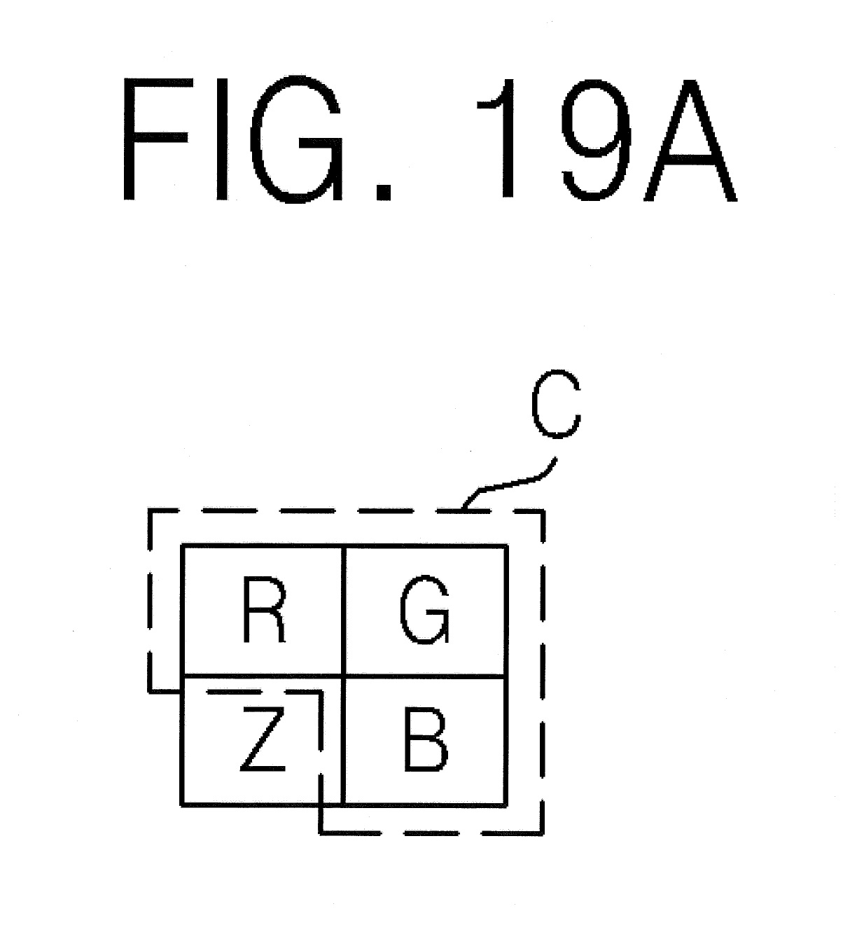

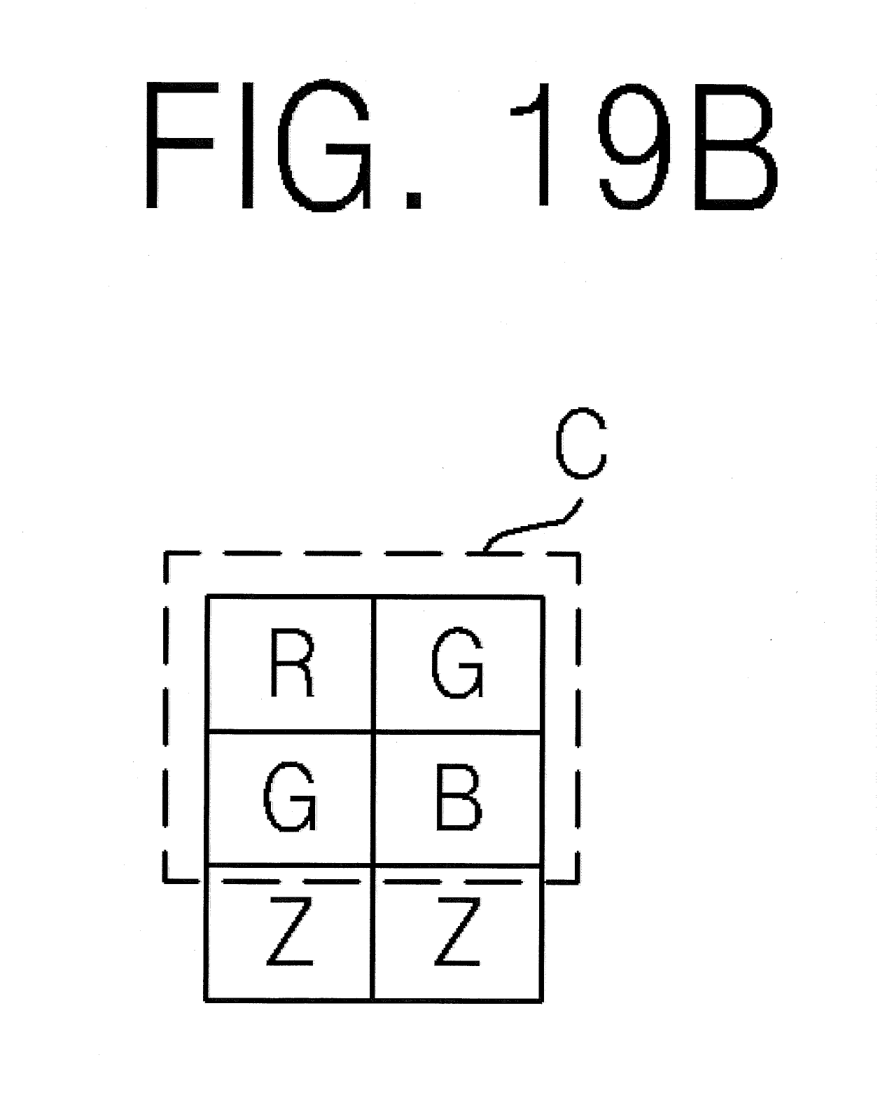

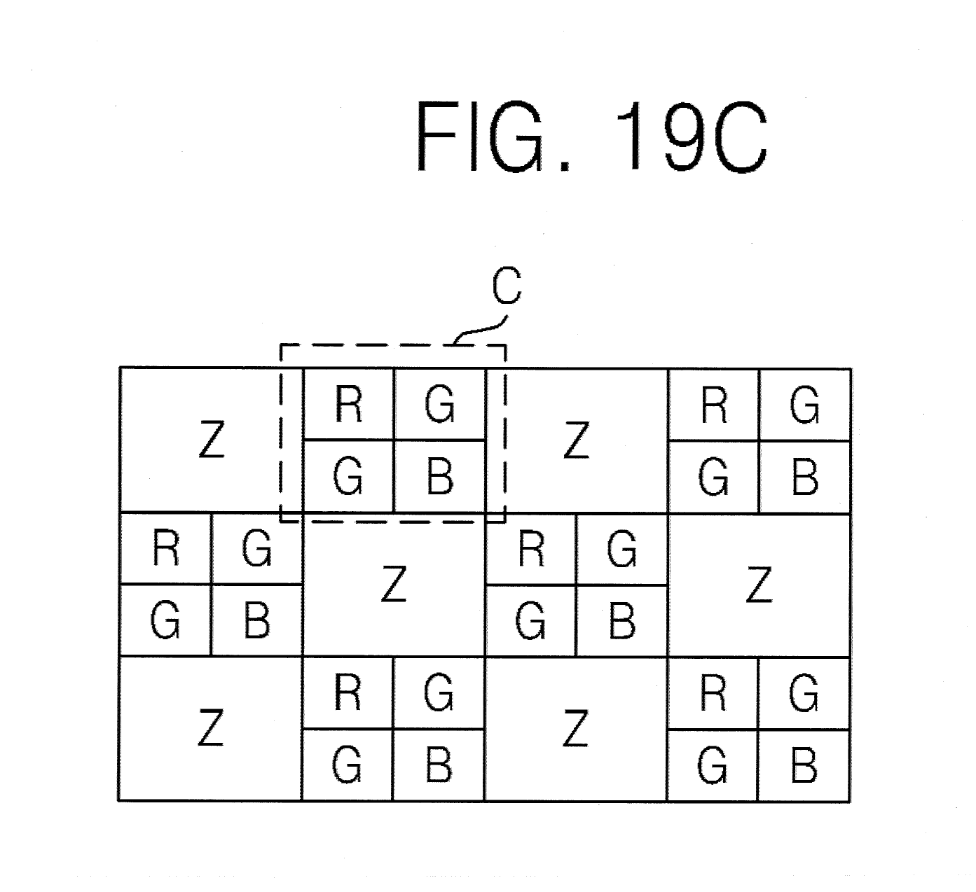

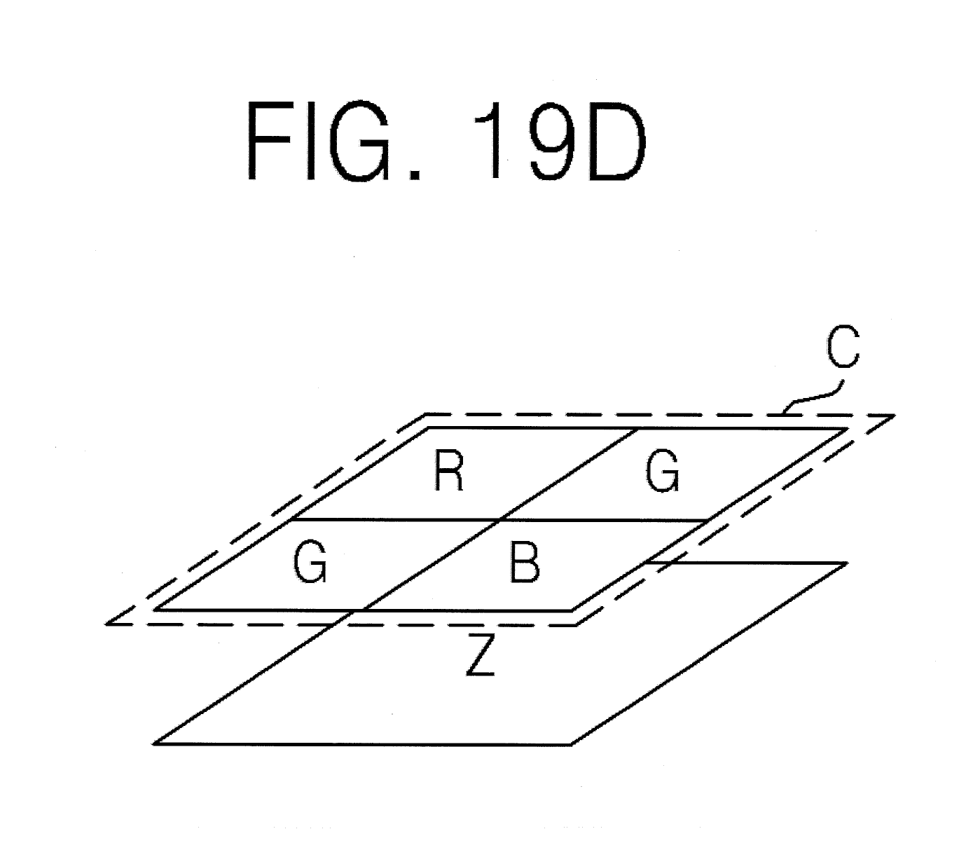

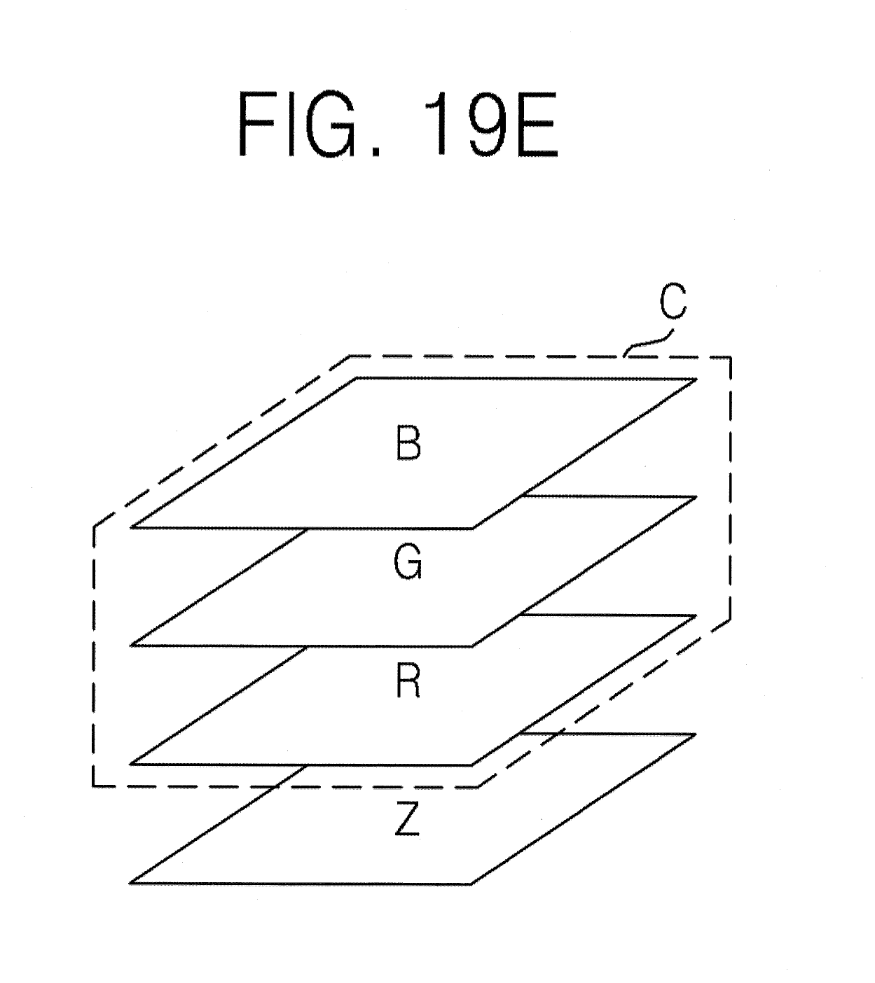

FIGS. 19A to 19E display example embodiments of a unit pixel included in the sensing array 35. Referring to FIG. 19A, a unit pixel array composing a part of the sensing array 35 may include a red pixel R, a green pixel G, a blue pixel B and a depth pixel Z.

A structure of the depth pixel Z may be the one-tap pixel structure as illustrated in FIG. 12 or the two-tap pixel structure as illustrated in FIG. 16. The depth pixel Z may generate a depth pixel signal corresponding to wavelengths of an infrared region.

The red pixel R, the green pixel G and the blue pixel B may be referred to as a color pixel C. The red pixel R generates a red pixel signal corresponding to wavelengths belonging to a red region among a visible light region, the green pixel G generates a green pixel signal corresponding to wavelengths belonging to a green region among the visible light region, and the blue pixel B generates a blue pixel signal corresponding to wavelengths belonging to a blue region among the visible light region. The color pixel C may be replaced with a magenta pixel, a cyan pixel and a yellow pixel.

The unit pixel arrays illustrated in FIGS. 19A to 19E are not limited in structure, and a pattern of the unit pixel array and pixels composing the pattern may change according to an example embodiment. For example, FIGS. 19D and 19E show that the color pixel C and the depth pixel Z may have three-dimensional configuration.

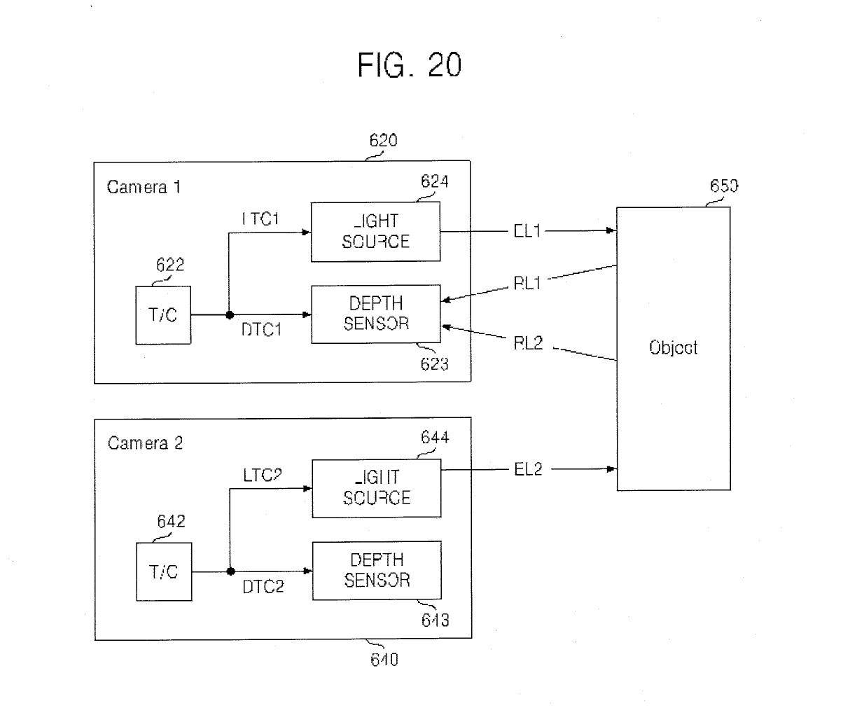

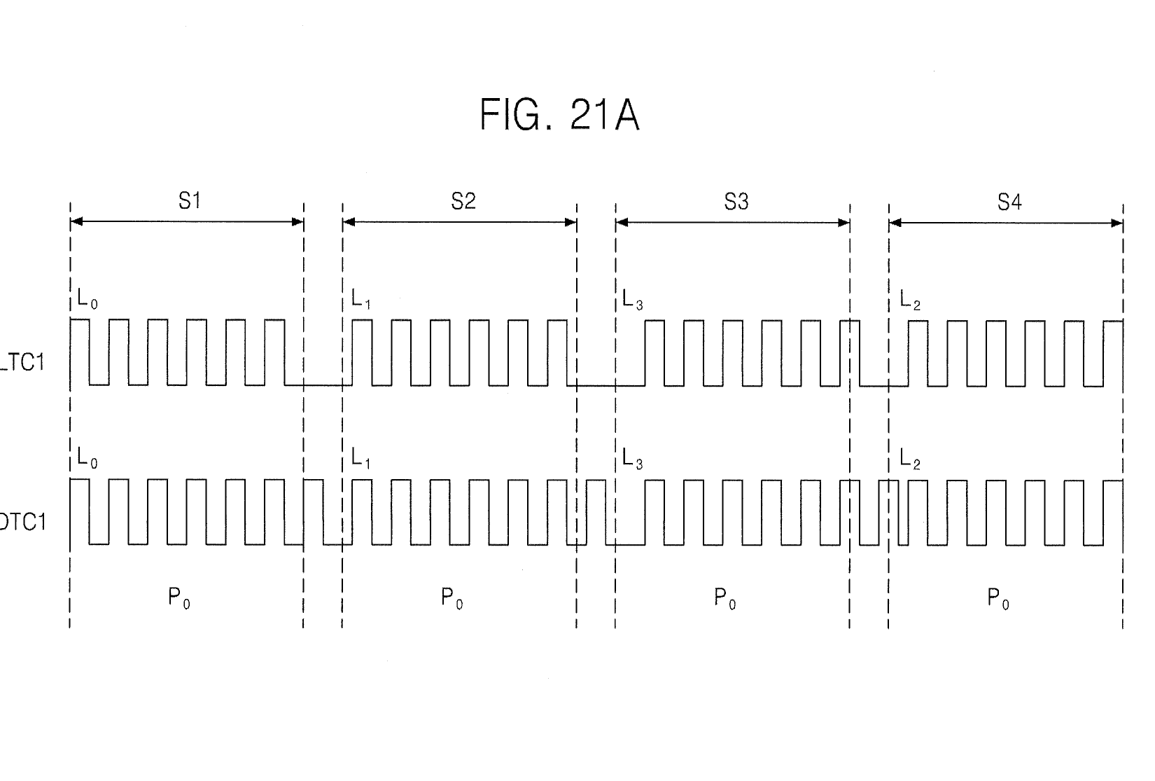

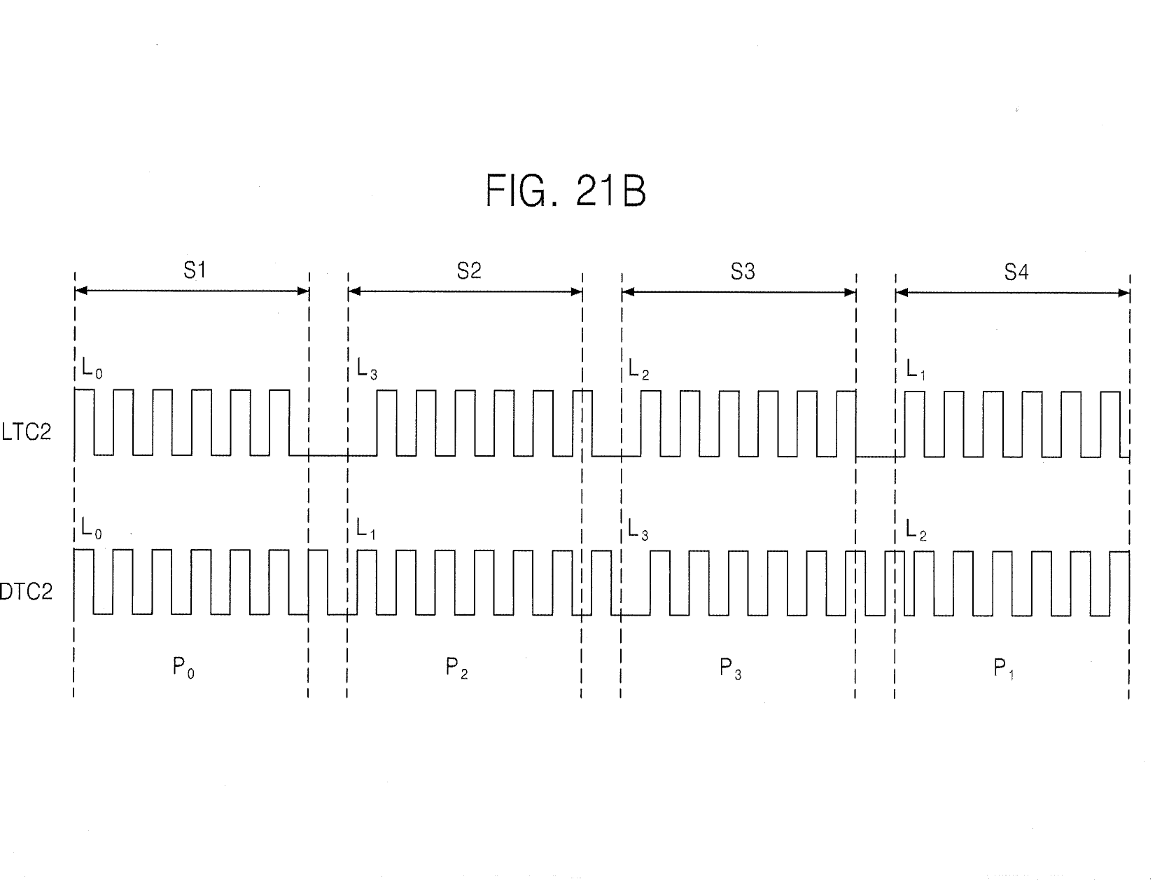

FIG. 20 illustrates a plurality of depth estimation devices 620 and 640, which are adjacently located and may experience signal interference. FIGS. 21A and 21B are timing diagrams illustrating a waveform of each optical emission control signal LTC and a waveform of an optical detection control signal DTC in depth estimation devices 620 and 640 according to at least one example embodiment. The plurality of depth estimation devices 620 and 640 located adjacently may emit optical signal EL1 or EL2 towards an identical object 650.

Referring to FIG. 20, a light source 624 of a first depth estimation device 620 may emit a first optical signal EL1 towards the object 650, and a light source 644 of a second depth estimation device 640 may emit a second optical signal EL2 towards the object 650. Then, a first reflected optical signal RL1 and a second reflected optical signal RL2 may be input to a depth sensor 623 of the first depth estimation device 620 together. Here, a first reflected optical signal RL1 is an optical signal reflected from the object 650 and incident by a first optical signal, and a second reflected optical signal RL2 is an optical signal reflected from the object 650 and incident by a second optical signal EL2. In this case, a optical signals RL1 or RL2 may interfere with each other. An error may occur as a result of the interference because the first depth estimation device 620 may calculate a depth based on reflected optical signal RL2 instead of on reflected optical RL1. However, the first depth estimation device 620 may overcome the interference error using an optical signal including a plurality of sequences having different phase differences according to at least one example embodiment.

As described above, a plurality of depth pixels included in depth sensors 623 and 643 of the depth estimation devices 620 and 640 accumulate optical charges during a desired time, e.g., an integration time, according to a plurality of gate signals G0 to G3, and output image pixel signals A0 to A3 generated according to an accumulation result.

According to at least one example embodiment, image pixel signals A0 to A3 include a sequence pixel signal P0 to P3, respectively. For example, an optical emission control signal LTC and optical detection signals DTC include sequences having different phase differences, respectively, so that sequence pixel signals P0 to P3 caused by a different phase difference per each of a plurality of sequences may be output.

Each image pixel signal (Aₖ) generated by each of a plurality of depth pixels is represented by equation 4.

$${A}_{k} = {\sum }_{n = 0}^{N} {P}_{m , n} \qquad [ Equation 4 ]$$

Here, k is 0 when a signal input to a photo gate of a depth pixel is a first gate signal G0, k is 1 when it is a second gate signal G1, k is 2 when it is a third gate signal G2, and k is 3 when it is a fourth gate signal G3.

In equation 4 P indicates a sequence pixel signal, n (n is a natural number) indicates an order of sequence, and m indicates a phase difference between a sequence waveform of an optical emission control signal and a sequence waveform of an optical detection control signal. According to at least one example embodiment, a first sequence pixel signal P0 is output when a sequence phase of an optical emission control signal is the same as a sequence phase of an optical detection control signal, a second sequence pixel signal P1 is output when a difference between a sequence phase of the optical emission control signal and a sequence phase of the optical detection control signal is 90°, a third sequence pixel signal P2 is output when a difference between a sequence phase of the optical emission control signal and a sequence phase of the optical detection control signal is 180°, and a fourth sequence pixel signal P3 is output when a difference between a sequence phase of the optical emission control signal and a sequence phase of the optical detection control signal is 270°. Sequence pixel signals P0 to P3 are expressed in an equation 5, an equation 6, an equation 7 and an equation 8, respectively.

P₀=α+β cos θ [Equation 5]

P₁=α+β sin θ [Equation 6]

P₂=α | β cos θ [Equation 7]

P₃=α+β sin θ [Equation 8]

In equations 5, 6, 7, and 8, each alpha (α) represents an offset and beta (β) represents an amplitude. The offset indicates background intensity.

FIG. 21A is a timing diagram illustrating a waveform of a first optical emission control signal LTC1 emitted from a first depth estimation device 620 and a waveform of a first optical detection control signal DTC1 output from the first depth estimation device 620. Referring to FIGS. 20 and 21A, a timing controller 622 of the first depth estimation device 620 transmits a first optical emission control signal LTC1 to a light source 624 and transmits a first optical detection control signal DTC1 to a depth sensor 643. For convenience of explanation, a waveform of an optical signal EU output from the light source 624 based on the first optical emission control signal LTC1 is assumed to be the same as a waveform of the first optical emission control signal LTC1, but is not limited thereto.

Still referring to FIG. 21A, a first sequence pixel signal P0 is derived during a first sequence S1 comparing a waveform of the first optical emission control signal LTC1 with a phase of the first optical detection control signal DTC1. Moreover, the first sequence pixel signal P0 is derived from each of a second sequence, a third sequence and a fourth sequence. In at least one example embodiment, a first sequence pixel signal P0 is calculated with an equation 5. Therefore, once an optical signal EU emitted from the first depth estimation device 620 is reflected from the object 650 and reaches the depth sensor 623, a depth may be estimated using an equation 9.

LTC 1_{A}_{₀}=P₀+P₀+P₀+P₀=4α+β cos {hacek over (\hat{θ} [Equation 9]

In equation 9, alpha (α) represents an offset, and beta (β) represents an amplitude. The offset indicates background intensity. Here, the first depth estimation device 620 may estimate depth information based on a phase difference (\hat{θ}).

FIG. 21B is a timing diagram illustrating a waveform of a second optical emission control signal LTC2 of a second depth estimation device 640 illustrated in FIG. 20 and a waveform of a second optical detection control signal DTC2 of a second depth estimation device 640. Referring to FIGS. 20 and 21B, a timing controller 642 of the second depth estimation device 640 transmits a second optical emission control signal LTC2 to a light source 644. The light source 644 emits an optical signal EL2 to an object 650 based on the second optical emission control signal LTC2. The emitted optical signal EL2 is reflected and incident to the depth sensor 623 of the first depth estimation device 620. For convenience of explanation, a waveform of the optical signal EL2 is assumed to be the same as a waveform of the second optical emission control signal LTC2.

According to at least one example embodiment, a sequence pixel signal may be derived by comparing a second optical emission control signal LTC2 of the second depth estimation device 640 with a first optical detection control signal DTC1 of the first depth estimation device 620. A phase of the first optical detection control signal DTC1 is the same as a phase of the second optical emission control signal LTC2 during a first sequence S1, so that a first sequence pixel signal P0 is derived. In addition, a phase of the first optical detection control signal DTC1 and a phase of the second optical emission control signal LTC2 have a difference of 180° during a third sequence S2, so that a third sequence pixel signal P2 is derived. During a fourth sequence S3, a phase of the first optical detection control signal DTC1 and a phase of the second optical emission control signal LTC2 have a difference of 270°, so that a fourth sequence pixel signal P2 is derived. In addition, a phase of the first optical detection control signal DTC1 and a phase of the second optical emission control signal LTC2 have a difference of 180° during a second sequence S2, so that a second pixel signal P1 is derived. Accordingly, once an optical signal EL2 emitted from the second depth estimation device is reflected from the object 650, a depth sensor of the first depth estimation device senses it and eliminates waveform interference using an equation 10.

LTC 2_{A}_{₀}=P′₀+P′₂+P′₃+P′₁=4α [Equation 10]

As shown in equation 10, when adding first to fourth sequence pixel signals, only 4α is left. Here, alpha (α) represents an offset. Therefore, although an optical signal EL2 emitted from the second depth estimation device is sensed by a depth sensor of the first depth estimation device, it is processed as a background signal and no interference occurs in estimating a depth.

A depth estimation device of at least one example embodiment offsets an interference effect by adding only the first to the fourth sequence pixel signals, however, it may cancel an interference phenomenon by adding more sequence pixel signals if needed.

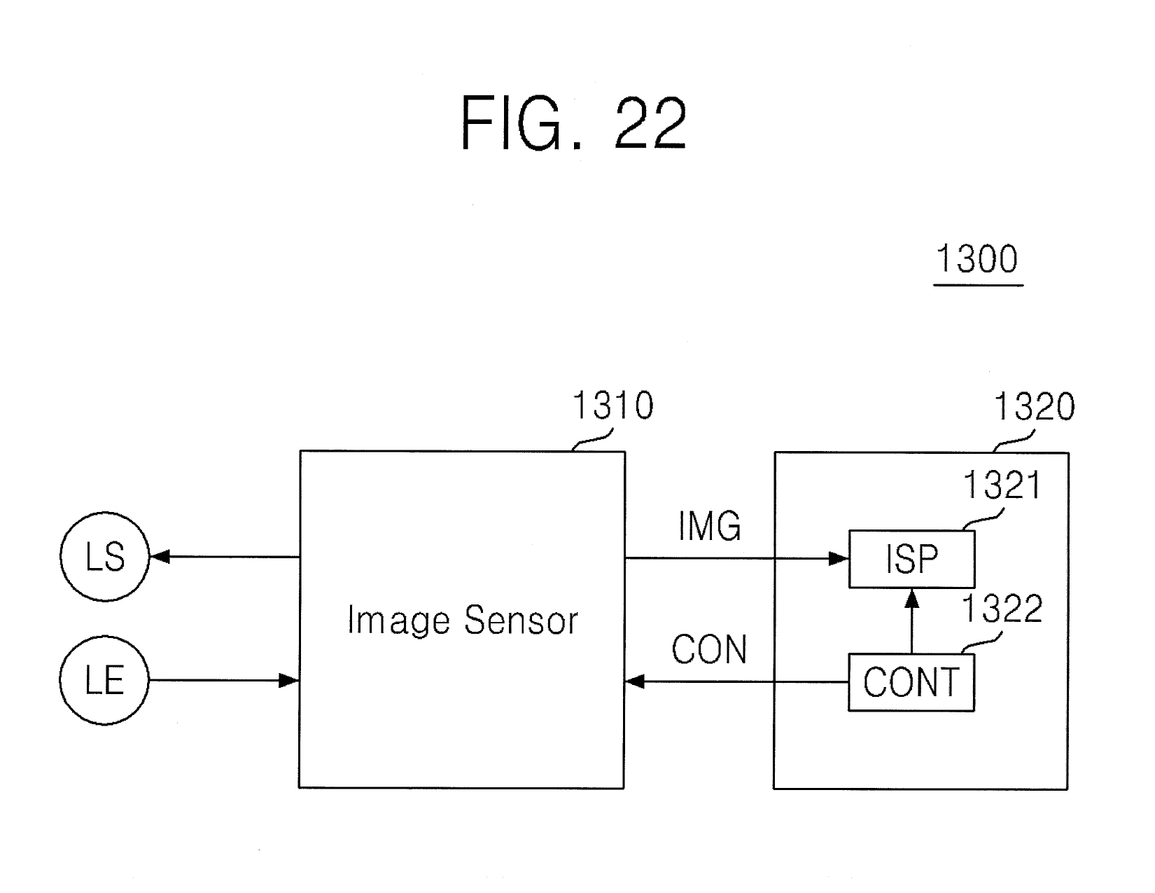

FIG. 22 is a drawing illustrating an image processing system according to at least one example embodiment. Referring to FIGS. 4 and 22, an image processing device or an image pick up device 1300 of the present invention may include an image sensor 1310 receiving a reflected light where an output light output from a light source LS is reflected from an object through a lens LE and sensing it as image information IMG of the object. The image processing device 1300 may further include a controller 1322 controlling an image sensor 1310 and a processor 1320 having a signal processing circuit 1321 performing a signal processing on image information sensed by the image sensor 1310.

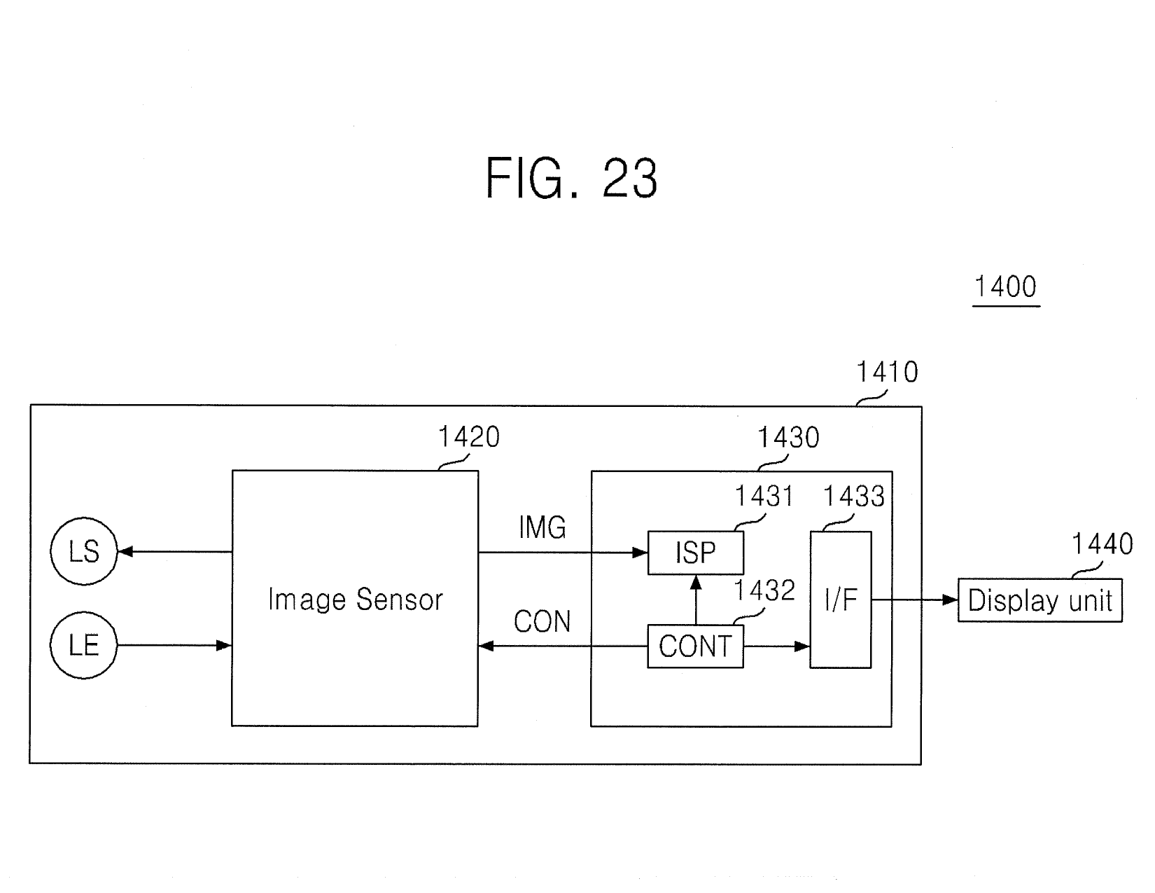

FIG. 23 is shows an image processing system according to at least another example embodiment. Referring to FIG. 23, an image processing system 1400 may have an image processing device 1410 and a display device 1440 displaying an image received from the image processing device 1410. The processor 1430 may further include an interface 1433 transmitting image information received from an image sensor 1420 to the display device 1440.

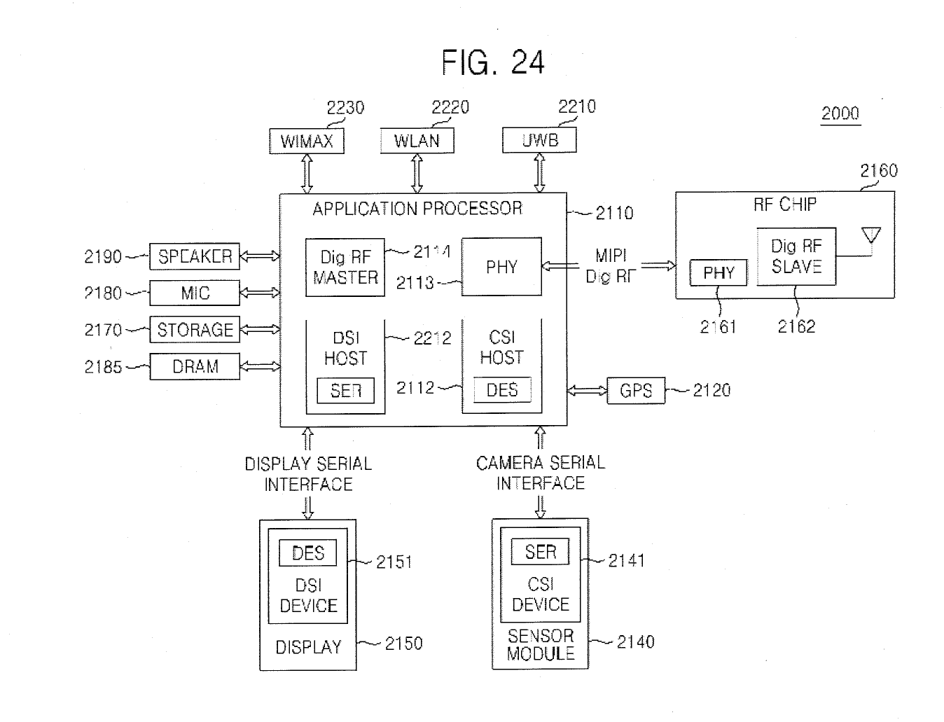

FIG. 24 shows an electronic system including the depth estimation device from in FIG. 1 or 4 and an interface. Referring to FIG. 24, an electronic system 2000 may be included in a data processing device which may use or support a mobile industry processor interface (MIPI®), e.g., a cellular phone, a personal digital assistant (PDA), a portable multimedia player (PMP), a tablet PC or a smart phone, etc. The electronic system 2000 includes an application processor 2110, an image sensor module 2140 and a display 2150.

A CSI host 2112 included in the application processor 2110 may perform a serial communication with a CSI device 2141 of the image sensor module 2140 through a camera serial interface (CSI). The CSI host 2112 may include a deserializer (DES) and the CSI device 2141 may include a serializer (SER).

A DSI host 2212 may perform a serial communication with a DSI device 2151 of a display 2150 through a display serial interface (DSI).

According to at least one example embodiment, the DSI host 2212 may include a serializer SER and a DSI device 2151 may include a deserializer (DES). The electronic system 2000 may further include a radio frequency (RF) chip 2160 performing a communication with the processor 2110. A PHY 2113 and a RF chip 2160 of the electronic system 2000 may transmit or receive data according to a mobile industry processor interface (MIPI®). The application processor 2110 may further include a Dig RF master 2114 controlling data transmission/reception according to a MIPI Dig RF of the PHY 2113. The electronic system 2000 may include a global positioning system (GPS) 2120, a storage 2170, a mike 2180, a dynamic random access memory (DRAM) 2185 and a speaker 2190. The electronic system 2000 may perform a communication by using Ultra Wideband (UWB) 2210, Wireless local area network (WLAN) 2200 and Worldwide Interoperability for Microwave Access (WIMAX) 2230. However, a configuration and an interface of the electronic system 2000 are an exemplification and it is not restricted thereto.

A depth sensor according to at least one example embodiment may estimate a depth to an object by erasing an interference phenomenon of optical signals caused by a plurality of depth estimation devices.

While example embodiments have been particularly shown and described, it will be understood by one of ordinary skill in the art that variations in form and detail may be made therein without departing from the spirit and scope of the claims.

1. A method of estimating a depth comprising:
outputting an optical signal to an object from a light source; and
estimating a depth between the object and the depth estimation device in response to a gate signal, which is based on the optical signal, and a reflected optical signal which is reflected from the object,
wherein the optical signal includes a plurality of sequences and a phase of a pulse of the optical signal is randomly changed for each of the plurality of sequences.

2. The method of claim 1, wherein the optical signal includes a delay time corresponding to a wavelength of the pulse between the plurality of sequences.

3. The method of claim 2, wherein a desired interval of the pulse is filtered during the delay time.

4. The method of claim 1, wherein the outputting the optical signal to the object includes:
outputting a pulse signal from a pulse generator and outputting a phase designated signal from a random number generator;
generating an optical emission control signal having different phases at a desired interval of the pulse signal based on the phase designated signal; and
outputting the optical signal from a light source based on the optical emission control signal.

5. The method of claim 4, wherein the random number generator outputs one of a plurality of phase designated signals as the phase designated signal.

6. The method of claim 1, wherein a plurality of gate signals for a whole frame are input sequentially to the depth estimation device and each phase of the plurality of gate signals varies by a desired phase.

7. The method of claim 1, wherein the estimating the depth between the object and the depth estimation device includes:
outputting a plurality of sequence pixel signals from a depth sensor in response to the reflected optical signal and the gate signal; and
estimating depth information through a phase difference between the reflected optical signal calculated based on the plurality of sequence pixel signals and the gate signal.

8. The method of claim 7, wherein the outputting of the plurality of sequence pixel signals processes the external optical signal as a background signal when values of the plurality of sequence pixel signals are randomly output in response to an external optical signal and the gate signal.

9. A method of a estimating a depth comprising:
generating an optical emission control signal in a timing controller,
controlling an optical signal and an optical detection control signal in the timing controller,
controlling a gate signal applied to a pixel in a depth sensor, the gate signal and the pixel including a plurality of sequences; and
adjusting a phase of a pulse randomly for each of the plurality of sequences.

10. The method of claim 9, wherein the optical emission control signal includes a delay time which is filtering-processed at a desired interval between the plurality of sequences.

11. The method of claim 9, wherein the optical emission control signal has a phase of the pulse changed for each of the plurality of sequences based on a phase designated signal.

12. The method of claim 9, wherein the gate signal is shifted by 90° from a phase of the optical detection control signal.

13-27. (canceled)

28. An operating method of a depth estimation device, the method comprising:
outputting an optical emission control signal and an optical detection control signal from a timing controller;
outputting an optical signal to an object based on the optical emission control signal; and
receiving a reflected optical signal from the object and estimating a distance to the object based on the optical signal and the reflected optical signal.

29. The method of claim 28, wherein outputting the optical emission control signal and the optical detection control signal from the timing controller includes:
generating a pulse from a pulse generator;
generating a random number from a random number generator;
delaying a phase of the pulse in a phase delay unit by an interval dᵣ based on the random number and outputting a result as the optical detection control signal; and
delaying the optical detection control signal in a pulse delay unit by an interval T_{w} and outputting a result as the optical emission control signal.

30. The method of claim 29, further comprising:
separating the pulse into a plurality of sequences in the phase delay unit, where the interval dᵣ represents different phase differences between each adjacent sequence in the plurality of sequences and the interval T_{w} represents a time delay between each adjacent sequence in the plurality of sequences.

31. The method of claim 28, wherein estimating the distance to the object includes:
generating a plurality of gate signals based on the optical detection control signal and outputting the plurality of gate signals sequentially;
sensing the reflected optical signal, detecting a phase difference between the reflected optical signal and at least one of the plurality of gate signals, and outputting image pixel signals;
sampling the image pixel signals and converting the image pixel signals to digital pixel signals; and
estimating the distance to the object based on phase differences between the digital pixel signals.

32. The method of claim 31, wherein each gate signal in the plurality of gate signals has a different phase difference.
